(19) United States
(12) Patent Application Publication
(10) Pub. No.: US 2009/0218933 A1
(43) Pub. Date: Sep. 3, 2009

(54) ORGANIC ELECTROLUMINESCENT DEVICE

(75) Inventors: Toshinori Matsushima, Nomi (JP); Noritaka Endo, Fukuoka-shi (JP); Chihaya Adachi, Fukuoka-shi (JP); Toshihiro Iwakuma, Sodegaura-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: IDEMITSU KOSAN CO., LTD, Chiyoda-ku (JP); KYUSHU UNIVERSITY, Fukuoka-shi (JP)

(21) Appl. No.: 12/201,214

(22) Filed: Aug. 29, 2008

(30) Foreign Application Priority Data
Mar. 3, 2008 (JP) 2008-052279

(51) Int. Cl. H01J 1/63

(52) U.S. Cl. 313/504

(57) ABSTRACT

An organic electroluminescence device including: an anode 10 and a cathode 20; two or more organic layers 30, 40 and 50 including an emitting layer 40 between the anode 10 and the cathode 20, the organic layers 30, 40 and 50 including, between the anode 10 and the emitting layer 40, a hole-injecting layer or a hole-transporting layer 30 which contains a thiophene derivative having a molecular weight of 1,200 or less; and an interfacial barrier reduction layer 60 being between two adjacent organic layers 30 and 40 selected from the organic layers 30, 40 and 50, the interfacial barrier reduction layer 60 containing a mixture of at least one material contained in one of the two adjacent organic layers 30 and 40 and at least one material contained in the other of the two adjacent organic layers 30 and 40 at a molar ratio of 1:1 to 1:4.

### TECHNICAL FIELD

The invention relates to an organic electroluminescence device.

### BACKGROUND

An organic electroluminescence device (hereinafter the term “electroluminescence” is often abbreviated as “EL”) is a self-emitting device utilizing the principle that a fluorescent substance emits light by the recombination energy of holes injected from an anode and electrons injected from a cathode when an electric field is impressed.

In recent years, demand for reduction of power consumption has been particularly increased in the field of a display which is incorporated into various information processing devices. To achieve this aim, attempts have been made to develop a light emitting device which can be driven at a low voltage.

For example, Patent Documents 1 through 5 each discloses an organic EL device in which a layer containing two or more substances is interposed between two layers. However, in these organic EL devices, the mixing ratio of the substances is not specified.

Patent Documents 6 and 7 each disclose an organic electroluminescence device having a layer containing a mixture of materials which constitute adjacent organic layers. Patent Document 7, in particular, states that polyethylene dioxythiophene (PEDOT) which is a polythiophene derivative obtained by doping polystyrene sulfonic acid (PSS) or the like can be used as a hole-injecting layer. However, since PEDOT/PSS contains an acidic substance, forming a layer in which PEDOT/PSS is mixed with other organic materials may cause the other organic materials to be denatured.

Patent Document 1: JP-A-2002-313584

Patent Document 2: JP-A-2007-042314

Patent Document 3: JP-A-2007-173545

Patent Document 4: JP-A-2007-221132

Patent Document 5: JP-A-2007-258745

Patent Document 6: JP-A-2002-324680

Patent Document 7: JP-A-2007-300137

The object of the invention is to provide an organic EL device which can be driven at a low voltage.

### DISCLOSURE OF THE INVENTION

The inventors have found that the driving voltage of the organic EL device can be significantly reduced by providing,between two organic layers between an anode and a cathode, a layer which contains materials of the two organic layers and further contains a specific compound. The invention has been made based on this finding.

The invention provides the following organic electroluminescence device.
1. An organic electroluminescence device comprising:

an anode and a cathode;

two or more organic layers including an emitting layer between the anode and the cathode, the organic layers including, between the anode and the emitting layer, a hole-injecting layer or a hole-transporting layer which contains a thiophene derivative having a molecular weight of 1,200 or less; and

an interfacial barrier reduction layer being between two adjacent organic layers selected from the organic layers, the interfacial barrier reduction layer containing a mixture of at least one material contained in one of the two adjacent organic layers and at least one material contained in the other of the two adjacent organic layers at a molar ratio of 1:1 to 1:4.
2. The organic electroluminescence device according to 1, wherein the hole-injecting layer, the hole-transporting layer or the interfacial barrier reduction layer adjacent to the hole-injecting layer or the hole-transporting layer contains an electron-accepting compound together with the thiophene derivative.
3. The organic electroluminescence device according to 2, wherein the electron-accepting compound contains a cyano group.
4. The organic electroluminescent device according to any one of 1 to 3, wherein the thiophene derivative is a thiophene derivative shown by the following formula (1):

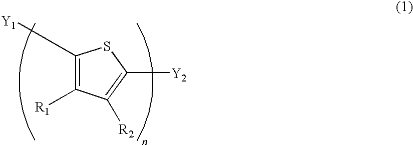

wherein R₁ and R₂ are independently a hydrogen atom, a halogen atom, a cyano group, an alkyl group having 1 to 20 carbon atoms, a haloalkyl group having 1 to 20 carbon atoms, an alkoxy group having 1 to 20 carbon atoms, an arylamino group having 6 to 40 carbon atoms, a substituted or unsubstituted aryl group having 6 to 40 ring carbon atoms or a substituted or unsubstituted heterocyclic group having 2 to 40 ring carbon atoms, and adjacent substituents may be bonded to each other to form a ring; Y₁ and Y₂ are independently a hydrogen atom or a substituted or unsubstitued monovalent group; and n is an integer of 1 to 12, provided that when n is 2 or more, R₁s and R₂s may be independently the same or different.
5. The organic electroluminescence device arroding to 4, wherein Y₁ and Y₂ in the formula (1) are independently a hydrogen atom, an alkyl group having 1 to 20 carbon atoms, a substituted or unsubstituted aryl group having 6 to 40 ring carbon atoms or a substituted or unsubstituted heterocyclic group having 2 to 40 ring carbon atoms.
6. An organic electroluminescence device comprising:

an anode and a cathode;

two or more organic layers including an emitting layer between the anode and the cathode, the emitting layer or a layer present between the emitting layer and the cathode containing an arylphosphine oxide derivative shown by the following formula (2); and

an interfacial barrier reduction layer being between two adjacent organic layers selected from the organic layers, the interfacial barrier reduction layer containing a mixture of at least one material contained in one of the two adjacent organic layers and at least one material contained in the other of the two adjacent organic layers:

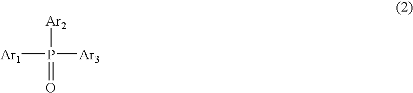

wherein Ar₁, Ar₂ and Ar₃ are independently an aromatic hydrocarbon group having 6 to 20 carbon atoms.
7. The organic electroluminescence device according to any one of 1 to 6, wherein the interfacial barrier reduction layer contains all the materials contained in both the adjacent organic layers.
8. The organic electroluminescent device accroding to any one of 1 to 7, wherein the organic layers contain a hole-transporting layer between the anode and the emitting layer, the interfacial barrier reduction layer is between the emitting layer and the hole-transporing layer and contains an emitting material contained in the emitting layer and a hole-transporing material contained in the hole-transporing layer.
9. The organic electroluminescence device according to any one of 1 to 8, wherein the organic layers include a hole-transporting layer and a hole-injecting layer between the anode and the emitting layer, and the interfacial barrier reduction layer is between the hole-injecting layer and the hole-transporting layer and contains a hole-injecting material contained in the hole-injecting layer and a hole-transporting material contained in the hole-transporting layer.
10. The organic electroluminescence device according to any one of 1 to 9, wherein the organic layers include an electron-transporting layer between the cathode and the emitting layer, and the interfacial barrier reduction layer is between the emitting layer and the electron-transporting layer and contains an emitting material contained in the emitting layer and an electron-transporting material contained in the electron-transporting layer.
11. The organic electroluminescence device according to any one of 1 to 10, wherein the organic layers include an electron-transporting layer and an electron-injecting layer between the cathode and the emitting layer and the interfacial barrier reduction layer is between the electron-injecting layer and the electron-transporting layer and contains an electron-injecting material contained in the electron-injecting layer and an electron-transporting material contained in the electron-transporting layer.
12. The organic electroluminescence device according to 8 or 9, wherein the hole-injecting material or the hole-transporting material is an arylamino compound.
13. The organic electroluminescence device according to any one of 1 to 12, wherein the interfacial barrier reduction layer contains a thiophene derivative shown by the following formula (1) and an arylamino compound:

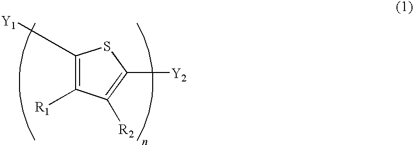

wherein R₁ and R₂ are independently a hydrogen atom, a halogen atom, a cyano group, an alkyl group having 1 to 20 carbon atoms, a haloalkyl group having 1 to 20 carbon atoms, an alkoxy group having 1 to 20 carbon atoms, an arylamino group having 6 to 40 carbon atoms, a substituted or unsubstituted aryl group having 6 to 40 ring carbon atoms or a substituted or unsubstituted heterocyclic group having 2 to 40 ring carbon atoms, and adjacent substitutents may be bonded to each other to form a ring; Y₁ and Y₂ are independently a hydrogen atom or a substituted or unsubstituted monovalent group; and n is an integer of 1 to 12, provided that when n is 2 or more, R₁s and R₂s may be independently the same or different.
14. The organic electroluminescence device according to any one of 1 to 13, wherein the interfacial barrier reduction layer contains an arylphosphine oxide derivative shown by the following formula (2) and an arylamino compound:

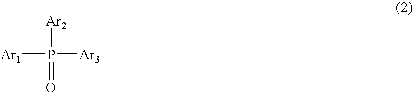

wherein Ar₁, Ar₂ and Ar₃ are independently an aromatic hydrocarbon group having 6 to 20 carbon atoms.

### ADVANTAGEOUS EFFECTS OF THE INVENTION

The invention provides an organic EL device which can be driven at a low voltage.

### BRIEF DESCRIPTION OF THE DRAWINGS

FIG. 1A is a view showing one embodiment of the organic EL device according to the invention;

FIG. 1B is a view showing another embodiment of the organic EL device according to the invention;

FIG. 2A is a view showing another embodiment of the organic EL device according to the invention;

FIG. 2B is a view showing another embodiment of the organic EL device according to the invention;

FIG. 3A is a view showing another embodiment of the organic EL device according to the invention;

FIG. 3B is a view showing another embodiment of the organic EL device according to the invention;

FIG. 4A is a graph showing current density-voltage characteristics of the organic EL devices fabricated in Examples 1 and 2 and Comparative Examples 1 and 2;

FIG. 4B is a graph showing current density-voltage characteristics of the organic EL devices fabricated in Examples 3 to 5;

FIG. 5A is a graph showing external quantum efficiency-current density characteristics of the organic EL devices fabricated in Examples 1 and 2 and Comparative Examples 1 and 2;

FIG. 5B is a graph showing external quantum efficiency-current density characteristics of the organic EL devices fabricated in Examples 3 to 5;

FIG. 6A is a graph showing luminous efficiency-current density characteristics of the organic EL devices fabricated in Examples 1 and 2 and Comparative Examples 1 and 2; and

FIG. 6B is a graph showing luminous efficiency-current density characteristics of the organic EL devices fabricated in Examples 3 to 5.

### BEST MODE FOR CARRYING OUT THE INVENTION

The organic EL device of the invention comprises an anode and a cathode and two or more organic layers including an emitting layer being present therebetween. In the invention, a layer containing a mixture of at least one material contained in one of the two adjacent layers and at least one material contained in the other of the two adjacent organic layers is provided between the two adjacent organic layers, thereby reducing the interfacial barrier between the adjacent two organic layers. Due to the provision of such an interfacial barrier reduction layer, driving voltage of the device can be decreased.

In addition to an emitting layer, the organic layers may include a hole-injecting layer, a hole-transporting layer, an electron-transporting layer, an electron-injection layer or the like. The interfacial barrier reduction layer may be provided between the emitting layer and the anode, between the emitting layer and the cathode, or between the emitting layer and the anode and between the emitting layer and the cathode. One or more interfacial barrier reduction layers may be provided depending on the number of the organic layers.

In addition, the interfacial barrier reduction layer includes at least one material contained in the two adjacent organic layers. However, the interfacial barrier reduction layer may contain all the materials contained in both the adjacent organic layers.

As for the materials in the two adjacent layers which are contained in the interfacial barrier reduction layer, the mixing ratio (molar ratio) of these materials is 1:1 to 1:4, preferably 1:1. Of the materials in the adjacent two layers, either material may be contained in a larger molar quantity. If the interfacial barrier reduction layer contains three or more materials, any two materials may satisfy the above-mentioned molar ratio.

Furthermore, it is preferred that these materials be mixed substantially uniformly in the interfacial barrier reduction layer. The “substantially uniformly” means that, in the thickness direction of the interfacial barrier reduction layer, there is no concentration gradient between an area near the middle of the interfacial barrier reduction layer and an area near the interface between the interfacial barrier reduction layer and the adjacent layer. It also means that there is no concentration gradient in the horizontal direction of the interfacial barrier reduction layer.

Furthermore, the organic EL device of the invention may preferably contain a hole-injecting layer or a hole-transporting layer between the anode and the emitting layer. The hole-injecting or the hole-transporting layer contains a thiophene derivative having a molecular weight of 1,200 or less. Due to the presence of the thiophene derivative, an organic EL device which can be driven stably at a significantly low driving voltage can be fabricated. The thiophene derivative does not contain an acidic substance unlike PEDOT/PSS (polyethylenedioxythiophene/polystyrene sulfonic acid)

In the invention, both the hole-injecting layer and the hole-transporting layer may contain a thiophene derivative.

In the organic EL device of the invention, an emitting layer or a layer between the emitting layer and the cathode may preferably contain an arylphosphine oxide derivative shown by the following formula (2). Due to the presence of the arylphosphine oxide derivative, an organic EL device which can be driven stably at a significantly low driving voltage can be fabricated.

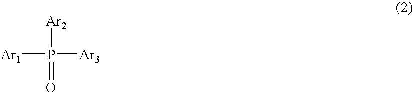

wherein Ar₁, Ar₂ and Ar₃ are independently an aromatic hydrocarbon group having 6 to 20 carbon atoms.

In the invention, both the emitting layer and a layer between the emitting layer and the cathode may contain a thiophene derivative.

The organic EL device of the invention will be described in detail with reference to the drawings. In the drawings, the same elements are indicated by the same reference numerals, and the description thereof is omitted.

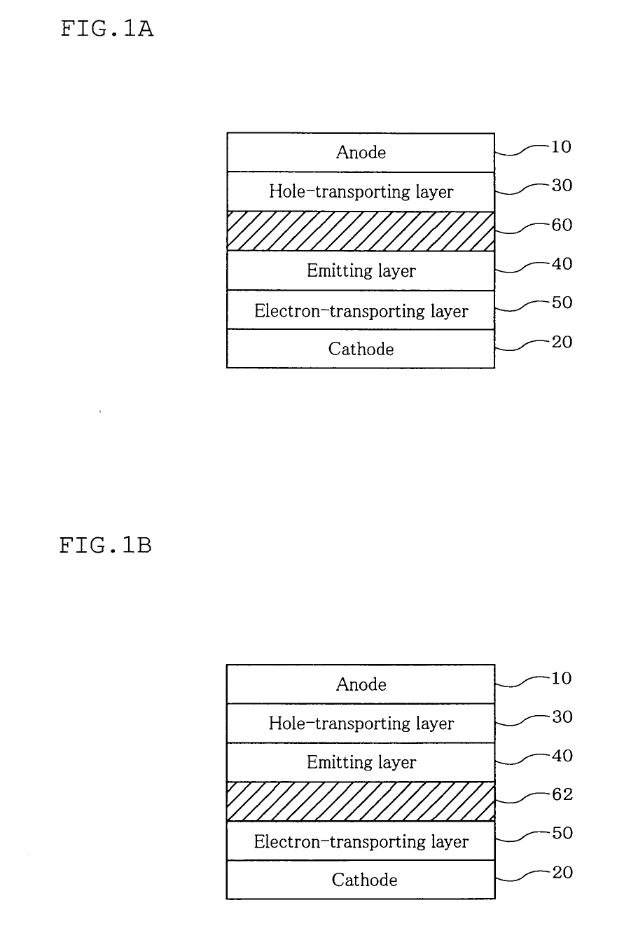

FIG. 1A is a view showing one embodiment of the organic EL device according to the invention.

The organic EL device in FIG. 1A contains, between an anode 10 and a cathode 20, three organic layers, i.e. a hole-transporting layer 30, an emitting layer 40 and an electron-transporting layer 50. Of these three organic layers, the interfacial barrier reduction layer maybe provided between any two of the organic layers. That is, it may be provided in one or more positions selected from between the hole-transporting layer 30 and the emitting layer 40 and between the emitting layer 40 and the electron-transporting layer 50. In FIG. 1A, the interfacial barrier reduction layer 60 is provided between the hole-transporting layer 30 and the emitting layer 40. In this case, the interfacial barrier reduction layer 60 contains an emitting material contained in the emitting layer 40 and a hole-transporting material contained in the hole-transporting layer 30. Furthermore, as shown in FIG. 1B, an interfacial barrier reduction layer 62 may be provided between the electron-transporting layer 50 and the emitting layer 40. This interfacial barrier reduction layer 62 contains an electron-transporting material contained in the electron-transporting layer 50 and an emitting material contained in the emitting layer 40.

In the first organic EL device of the invention, the hole-transporting layer 30 contains a thiophene derivative having a molecular weight of 1,200 or less. It is preferred that the interfacial barrier reduction layer 60 also contain this thiophene derivative.

In the second organic EL device of the invention, the emitting layer 40 or the electron-transporting layer 50 contains an arylphosphine oxide derivative shown by the above formula (2). It is preferred that the interfacial barrier reduction layer 62 also contain this arylphosphine oxide derivative.

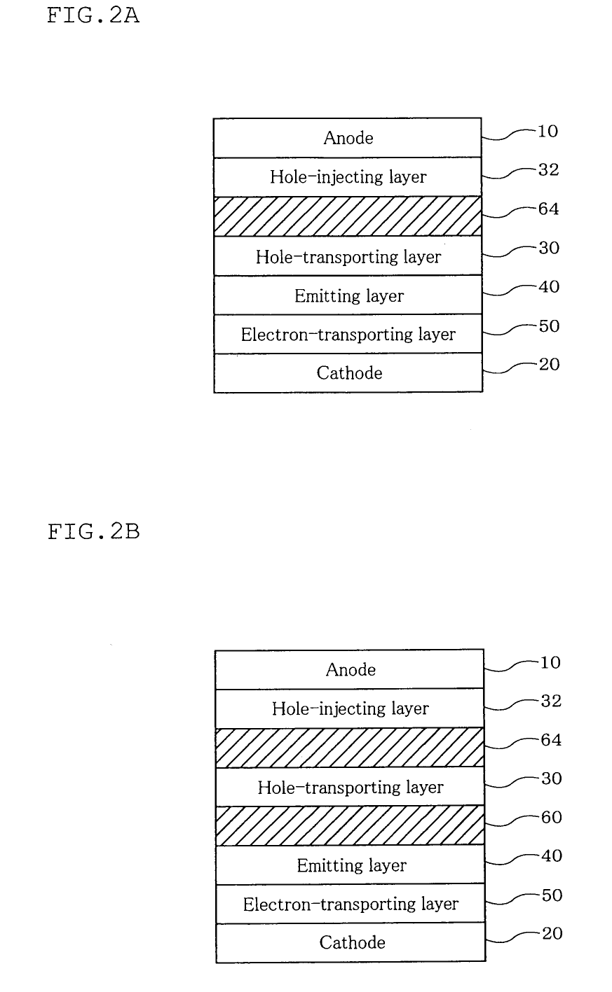

FIG. 2A is a view showing another embodiment of the organic EL device according to the invention.

In FIG. 2A, the organic EL device contains, between the anode 10 and the cathode 20, four organic layers, i.e. a hole-injecting layer 32, the hole-transporting layer 30, the emitting layer 40 and the electron-transporting layer 50. The interfacial barrier reduction layer may be provided between any two of the organic layers. That is, it may be provided at one or more positions selected from between the hole-injecting layer 32 and the hole-transporting layer 30, between the hole-transporting layer 30 and the emitting layer 40 and between the emitting layer 40 and the electron-transporting layer 50. In FIG. 2A, an interfacial barrier reduction layer 64 is provided between the hole-injecting layer 32 and the hole-transporting layer 30. In this case, the interfacial barrier reduction layer 64 contains a hole-injecting material contained in the hole-injecting layer 32 and a hole-transporting material contained in the hole-transporting layer 30. Furthermore, as shown in FIG. 2B, the interfacial barrier reduction layer 60 may further be provided between the hole-transporting layer 30 and the emitting layer 40. This interfacial barrier reduction layer 60 contains a hole transporting material contained in the hole-transporting layer 30 and an emitting material contained in the emitting layer 40.

In the first organic EL device of the invention, the hole-injecting layer 32 or the hole-transporting layer 30 contains a thiophene derivative having a molecular weight of 1,200 or less. It is preferred that the interfacial barrier reduction layers 60 and 64 each contain this thiophene derivative.

In the second organic EL device of the invention, the emitting layer 40 or the electron-transporting layer 50 contains an arylphosphine oxide derivative shown by the above formula (2).

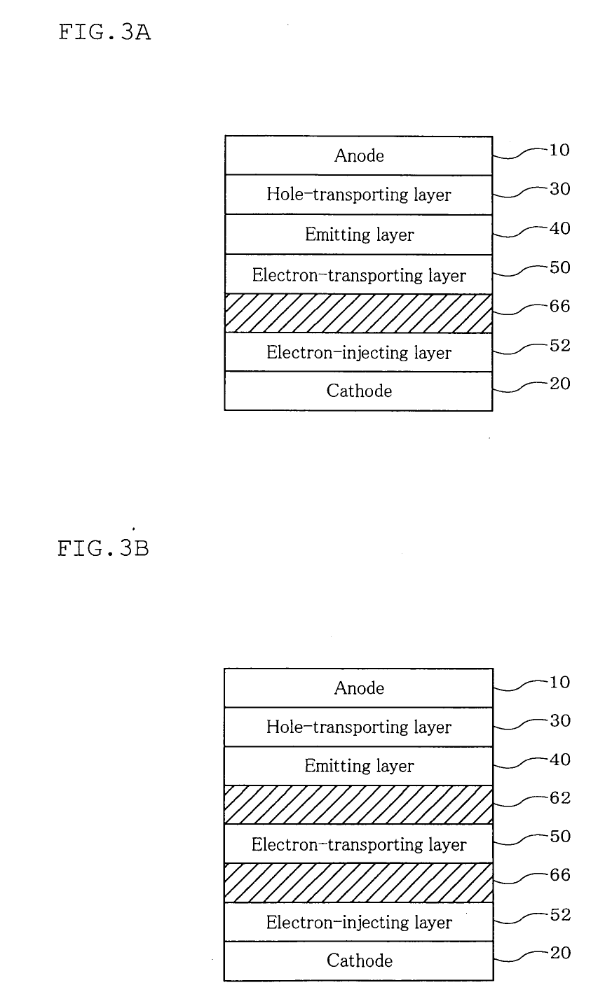

FIG. 3A is a view showing another embodiment of the organic EL device according to the invention.

In FIG. 3A, the organic EL device contains, between the anode 10 and the cathode 20, four organic layers, i.e. the hole-transporting layer 30, the emitting layer 40, the electron-transporting layer 50 and an electron-injecting layer 52. Of these four organic layers, the interfacial barrier reduction layer may be provided between any two of the organic layers. That is, it may be provided at one or more positions selected from between the hole-transporting layer 30 and the emitting layer 40, between the emitting layer 40 and the electron-transporting layer 50 and between the electron-transporting layer 50 and the electron-injecting layer 52. In FIG. 3A, an interfacial barrier reduction layer 66 is provided between the electron-injecting layer 52 and the electron-transporting layer 50. In this case, the interfacial barrier reduction layer 66 contains an electron-injecting material contained in the electron-injecting layer 52 and an electron-transporting material contained in the electron-transporting layer 50. Furthermore, as shown in FIG. 3B, the interfacial barrier reduction layer 62 may further be provided between the electron-transporting layer 50 and the emitting layer 40. This interfacial barrier reduction layer 62 contains an electron-transporting material contained in the electron-transporting layer 50 and an emitting material contained in the emitting layer 40.

In the first organic EL device according to the invention, the hole-transporting layer 30 contains a thiophene derivative having a molecular weight of 1,200 or less.

In the second organic EL device according to the invention, the emitting layer 40, the electron-transporting layer 50 or the electron-injecting layer 52 contains an arylphosphine oxide derivative shown by the above formula (2). It is preferred that the interfacial barrier reduction layers 62 and 66 each contain this arylphosphine oxide derivative.

In the organic EL device of the invention, the above-mentioned thiophene derivative having a molecular weight of 1,200 or less is preferably a thiophene derivative shown by the following formula (1). The thiophene derivative having a molecular weight of 1,200 or less is a hole-injecting material or a hole-transporting material which can be contained in the hole-injecting layer, the hole-transporting layer, the interfacial barrier reduction layer or the like.

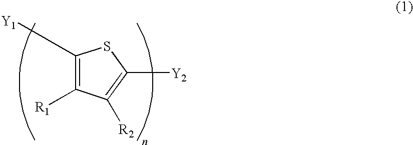

wherein R₁ to R₂ are independently a hydrogen atom, a halogen atom, a cyano group, an alkyl group having 1 to 20 carbon atoms, a haloalkyl group having 1 to 20 carbon atoms, an alkoxy group having 1 to 20 carbon atoms, an arylamino group having 6 to 40 carbon atoms, a substituted or unsubstituted aryl group having 6 to 40 carbon atoms that form a ring (hereinafter referred to as “ring carbon atoms”), or a substituted or unsubstituted heterocyclic group having 2 to 40 ring carbon atoms, provided that adjacent substituents may be bonded to each other to form a ring; Y₁ and Y₂ are independently a hydrogen atom or a substituted or unsubstituted monovalent group; and n is an integer of 1 to 12, provided that when n is 2 or more, R₁s and R₂s may be independently the same or different from each other.

In the formula (1), as the halogen atom, fluorine, chlorine, bromine, iodine or the like may be given.

Examples of the alkyl group having 1 to 20 carbon atoms include methyl, ethyl, propyl, iropropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecycl, n-octadecyl, neopentyl, 1-methylpentyl, 2-methylpentyl, 1-pentylhexyl, 1-butylpentyl, 1-heptyloctyl, 3-methylpentyl, cyclopentyl, cyclohexyl, cyclooctyl and 3,5-tetramethylcyclohexyl.

Of these, methyl, ethyl, propyl, isopropyl, n-butyl, s-butyl, isobutyl, t-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, neopentyl, 1-methylpentyl, 1-pentylhexyl, 1-butylpentyl, 1-heptyloctyl, cyclohexyl, cyclooctyl and 3,5-tetramethylcyclohexyl are preferable.

Examples of the haloalkyl group having 1 to 20 carbon atoms include fluoromethyl, difluoromethyl, trifluoromethyl and pentafluoroethyl. Fluoromethyl, difluoromethyl and trifluoromethyl are preferable.

As examples of the alkoxy group having 1 to 20 carbon atoms, a group shown by —OY can be given. As specific examples of Y, the same groups as those given as the examples of the above-mentioned alkyl group can be given. The same applies for preferable examples.

As examples of the arylamino group having 6 to 40 ring carbon atoms, diphenylamino, orphenyl, naphthyl, anthracenyl, triphenylenyl, fluoranthenyl, biphenyl or the like each having diphenylamino or amino as a substituent can be given. Phenyl or naphthyl having diphenylamino or amino as a substituent is preferable.

Examples of the aryl group having 6 to 40 carbon atoms include phenyl, naphthyl, biphenyl, anthracenyl and triphenylenyl.

As the substituent, methyl, ethyl, cyclohexyl, isopropyl, butyl, phenyl or the like can be given.

A substituted or unsubstituted phenyl, naphthyl or biphenyl is preferable.

Examples of the substituted or unsubstituted heterocyclic groups having 2 to 40 carbon atoms include 1-pyrrolyl, 2-pyrrolyl, 3-pyrrolyl, pyrazinyl, 2-pyridinyl, 1-imidazolyl, 2-imidazolyl, 1-pyrazolyl, 1-indolydinyl, 2-indolydinyl, 3-indolydinyl, 5-indolydinyl, 6-indolydinyl, 7-indolydinyl, 8-indolydinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 9-carbazolyl, β-carboline-1-yl, β-carboline-3-yl, β-carboline-4-yl, β-carboline-5-yl, β-carboline-6-yl, β-carboline-7-yl, β-carboline-6-yl, β-carboline-9-yl, 1-phenanthrydinyl, 2-phenanthrydinyl, 3-phenanthrydinyl, 4-phenanthrydinyl, 6-phenanthrydinyl, 7-phenanthrydinyl, 8-phenanthrydinyl, 9-phenanthrydinyl, 10-phenanthrydinyl, 1-acrydinyl, 2-acrydinyl, 3-acrydinyl, 4-acrydinyl, 9-acrydinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl, 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 10-phenothiazinyl, 1-phenoxazinyl, 2-phenoxazinyl, 3-phenoxazinyl, 4-phenoxazinyl, 10-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methylpyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl 1-indolyl, 4-t-butyl 1-indolyl, 2-t-butyl 3-indolyl, 4-t-butyl 3-indolyl, 1-dibenzofuranyl, 2-dibenzofuranyl, 3-dibenzofuranyl, 4-dibenzofuranyl, 1-dibenzothiophenyl, 2-dibenzothiophenyl, 3-dibenzothiophenyl, 4-dibenzothiophenyl, 1-silafluorenyl, 2-silafluorenyl, 3-silafluorenyl, 4-silafluorenyl, 1-germafluorenyl, 2-germafluorenyl, 3-germafluorenyl and 4-germafluorenyl.

Of these, 2-pyridinyl, 1-indolidinyl, 2-indolidinyl, 3-indolidinyl, 5-indolidinyl, 6-indolidinyl, 7-indolidinyl, 8-indolidinyl, 2-imidazopyridinyl, 3-imidazopyridinyl, 5-imidazopyridinyl, 6-imidazopyridinyl, 7-imidazopyridinyl, 8-imidazopyridinyl, 3-pyridinyl, 4-pyridinyl, 1-indolyl, 2-indolyl, 3-indolyl, 4-indolyl, 5-indolyl, 6-indolyl, 7-indolyl, 1-isoindolyl, 2-isoindolyl, 3-isoindolyl, 4-isoindolyl, 5-isoindolyl, 6-isoindolyl, 7-isoindolyl, 1-carbazolyl, 2-carbazolyl, 3-carbazolyl, 4-carbazolyl, 9-carbazolyl, 1-dibenzofuranyl, 2-dibenzofuranyl, 3-dibenzofuranyl, 4-dibenzofuranyl, 1-dibenzothiophenyl, 2-dibenzothiophenyl, 3-dibenzothiophenyl, 4-dibenzothiophenyl, 1-silafluorenyl, 2-silafluorenyl, 3-silafluorenyl, 4-silafluorenyl, 1-germafluorenyl, 2-germafluorenyl, 3-germafluorenyl and 4-germafluorenyl are preferable.

As the substituent, methyl, ethyl, cyclohexyl, isopropyl, butyl, phenyl or the like can be given.

R₁ and R₂ may be bonded to each other to form a ring. Examples of the ring include a benzene ring, a cyclohexyl ring and a naphthyl ring.

Y₁ and Y₂ in formula (1) are independently a hydrogen atom, an alkyl group having 1 to 20 carbon atoms, a substituted or unsubstituted aryl group having 6 to 40 ring carbon atoms or a substituted or unsubstituted heterocyclic group having 2 to 40 ring carbon atoms. Examples of the alkyl group, the aryl group or the heterocyclic group are the same as those for the examples of R₁ and R₂.

Specific examples of the thiophene derivative shown by formula (1) are given below.

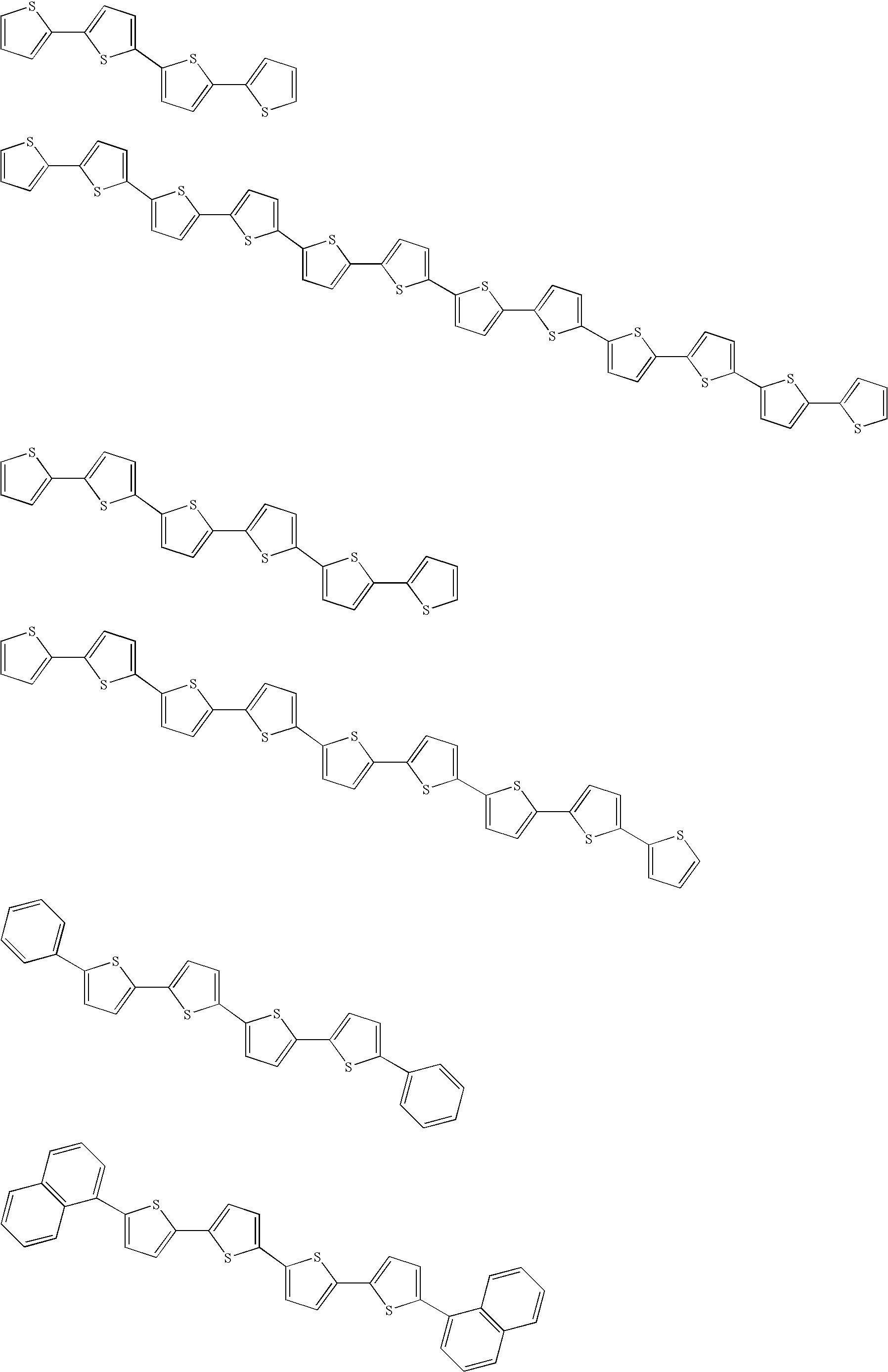

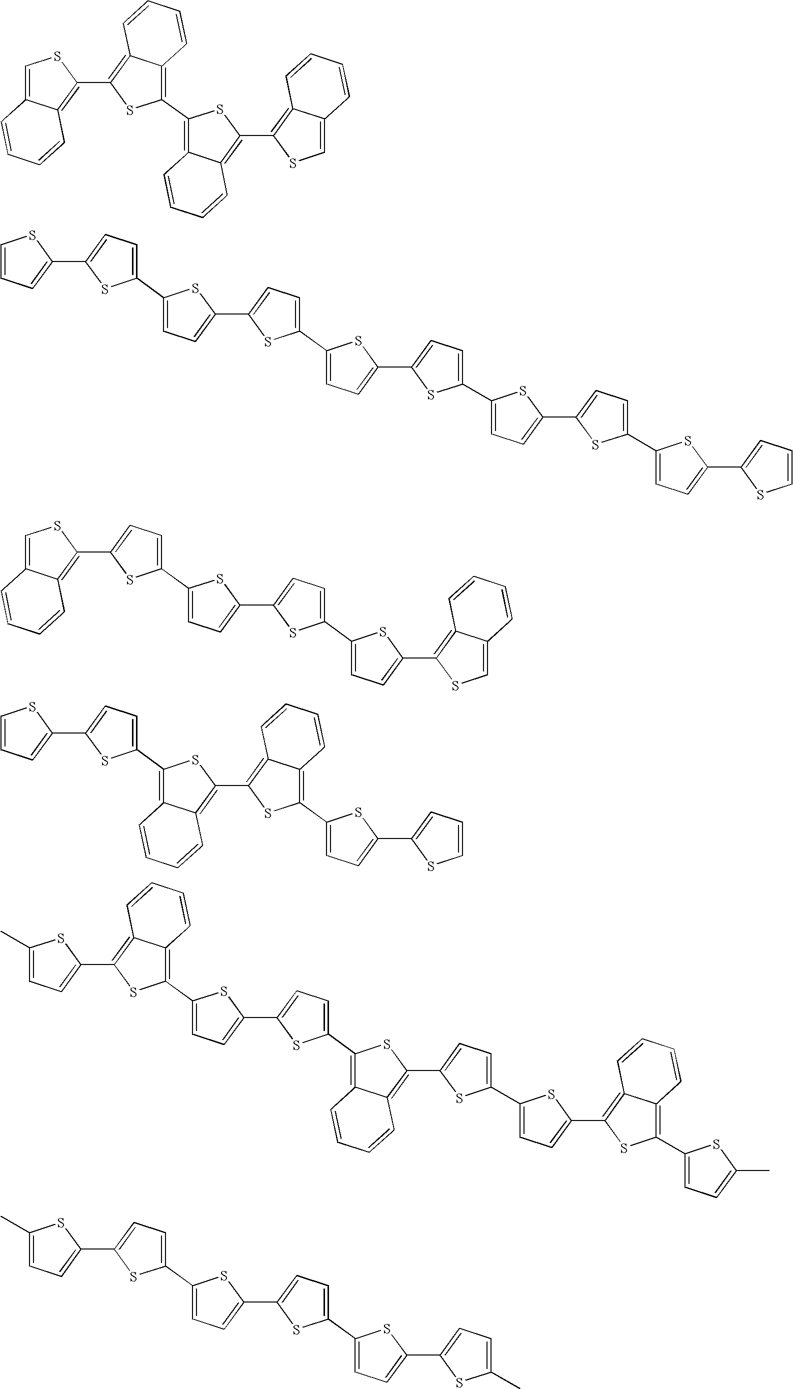

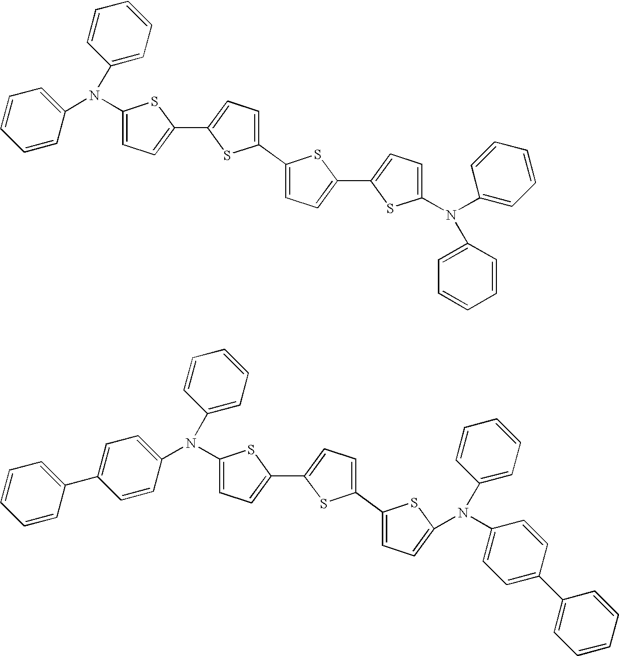

As the thiophene derivative shown by formula (1), commercial products or those synthesized by a known method can be used. Reference can be made to Japanese Patent No. 2826381, etc. for the synthesis method.

It is preferred that the hole-injecting layer, the hole-transporting layer or the interfacial barrier reduction layer of the invention contain a compound having electron accetability for the thiophene derivative (electron-acceptable compound) together with the thiophene derivative shown by the formula (1). Due to the presence of the electron-acceptable compound, the organic EL device can have improved carrier balance.

As the electron-acceptable compound, an organic compound having an electron-attracting substituent or an electron-deficient ring or a metal oxide can be used.

As the electron-attracting substituent, halogen, cyano, trifluoromethyl, carbonyl, nitro, aryl boron or the like can be given. In particular, cyano is preferable.

Examples of the electron-deficient ring include 2-pyridyl, 3-pyridyl, 4-pyridyl, 2-quinolyl, 3-quinolyl, 4-quinolyl, 2-imidazole, 4-imidazole, 3-pyrazole, 4-pyrazole, pyridazine, pyrimidine, pyrazine, cinnoline, phthalazine, quinazoline, quinoxaline, 3-(1,2,4-N)-triazolyl, 5-(1,2,4-N)-triazolyl, 5-tetrazolyl, 4-(1-O, 3-N)-oxazole, 5-(1-O, 3-N)-oxazole, 4-(1-S, 3-N)-thiazole, 5-(1-S, 3-N)-thiazole, 2-benzoxazole, 2-benzothiazole, 4-(1,2,3-N)-benzotriazole and benzimidazole.

Preferred examples of the electron-acceptable compound include a quinoid derivative, an arylborane derivative, a thiopyrane dioxide derivative and an imide derivative such as a naphthalimide derivative, and a hexaazatriphenylene derivative.

For example, the following quinoid derivatives can be given.

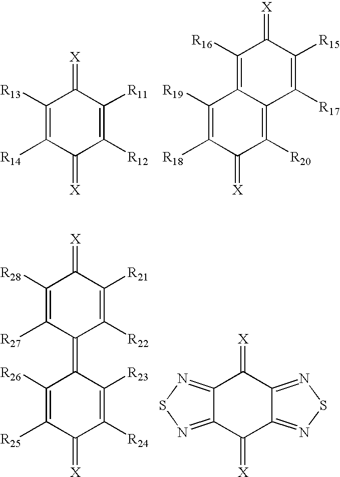

wherein R₁₁ to R₂₈ are independently hydrogen, halogen, fluoroalkyl, cyano, alkoxy, alkyl or aryl, excluding the case where all of R₁₁ to R₂₈ are hydrogen in the same molecule.

Fluorine and chlorine are preferable as the halogen represented by R₁₁ to R₂₈.

Trifluoromethyl and pentafluoroethyl are preferable as the fluoroalkyl group represented by R₁₁ to R₂₈.

Methoxy, ethoxy, iso-propoxy and tert-butoxy are preferable as the alkoxy group represented by R₁₁ to R₂₈.

Methyl, ethyl, propyl, iso-propyl, tert-butyl and cyclohexyl are preferable as the alkyl group represented by R₁₁ to R₂₈.

Phenyl and naphthyl are preferable as the aryl group represented by R₁₁ to R₂₈.

X is an electron-attracting group and has any of the structures shown by the following formulas (j) to (p). It is preferred that X have a structure represented by the formulas (j), (k) and (1).

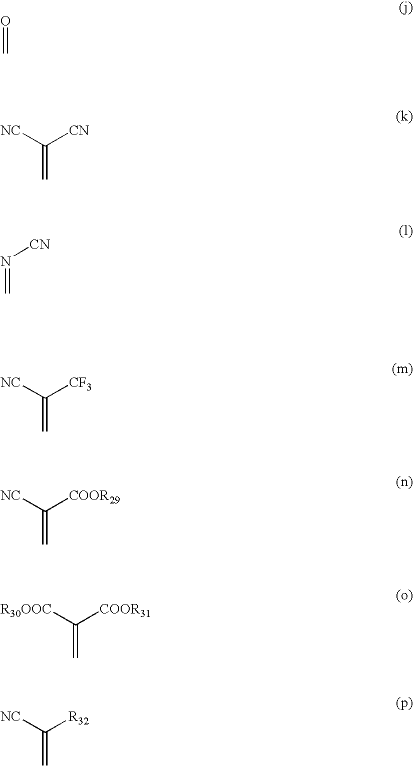

wherein R₂₉ to R₃₂ are independently hydrogen, fluoroalkyl, alkyl, aryl or heterocycle; and R₃₀ and R₃₁ may be bonded to each other to form a ring.

The fluoroalkyl group, alkyl group, and aryl group for R₂₉ to R₃₂ are the same as those for R₁₁ to R²⁸.

As the heterocyclic ring for R₂₉ to R₃₂, substituents of the following formulas are preferable.

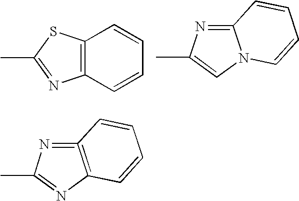

When R₃₀ and R₃₁ form a ring, X is preferably a substituent of the following formula.

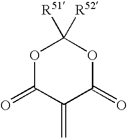

wherein R^{51′} and R^{52′} are independently a methyl group, ethyl group, propyl group or tert-butyl group.

In the invention, of the above-mentioned electron-acceptable compounds, one which contains a cyano group is particularly preferable.

Specific examples of the quinoid derivative which exhibits electron acceptability for the thiophene derivative are shown below.

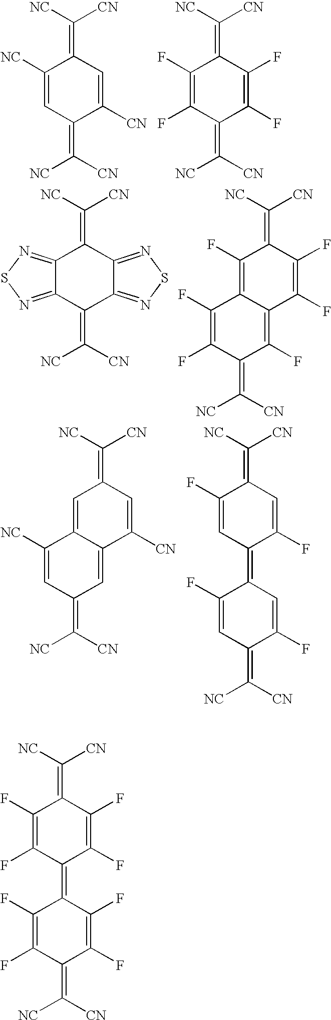

As the electron-acceptable compound, compounds shown by the following formula can be given.

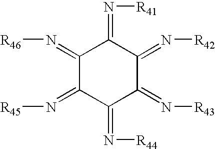

wherein R₄₁, R₄₂, R₄₃, R₄₄, R₄₅ and R₄₆ are any of a substituted or unsubstituted alkyl group, a substituted or unsubstituted aryl group, a substituted or unsubstituted aralkyl group, and a substituted or unsubstituted heterocyclic group; R₄₁, R₄₂, R₄₃, R₄₄, R₄₅ and R₄₆ may be the same or different; R₄₁ and R₄₂, R₄₃ and R₄₄, R₄₅ and R₄₆, or R₄₁ and R₄₆, R₄₂ and R₄₃, R₄₄ and R₄₅ may form a condensed ring.

A compound shown by the following formula is preferable.

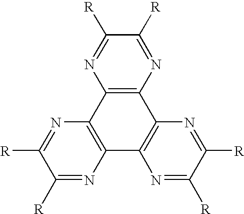

wherein Rs are independently a halogen atom, a cyano group, a nitro group, an alkyl group, a trifluoromethyl group, an aryloxycarbonyl group, an alkoxycarbonyl group, a dialkylcarbamoyl group, a diarylcarbamoyl group, or a carboxyl group.

It is particularly preferred that R be a cyano group.

It is preferred that the electron-acceptable compound be contained preferably in an amount of 1 to 60 mol %, more preferably 1 to 40 mol %, in terms of weight molar fraction, relative to the thiophene derivative represented by the above formula (1).

The hole-injecting layer and the hole-transporting layer may be formed of a thiophene derivative and an electron-acceptable compound, or may be formed of a mixture of a thiophene derivative, an electron-acceptable compound and a material mentioned later.

In the organic EL device of the invention, the hole-injecting material or the hole-transporting material to be contained in the hole-injecting layer, the hole-transporting layer and the interfacial barrier reduction layer is preferably an arylamino compound. An explanation will be given later for the arylamino compound.

Furthermore, in the organic EL device of the invention, an emitting material to be contained in the emitting layer, the electron-transporting layer, the electron-injecting layer, the interfacial barrier reduction layer or the like is preferably an arylphosphine oxide derivative shown by the following formula (2):

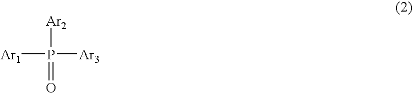

wherein Ar₁, Ar₂ and Ar₃ are independently an aromatic hydrocarbon group having 6 to 20 carbon atoms.

In formula (2), it is preferred that Ar₁, Ar₂ and Ar₃ be independently phenyl, naphthyl, anthracenyl, pyrenyl, perylenyl, fluoranthenyl, chrycenyl, biphenyl, terphenyl, fluorenyl, phenanthrenyl or triphenylenyl, with a group formed of 1 to 4 substituted or unsubstituted benzene rings being particularly preferable.

If the organic layer of the organic EL device of the invention contains the above-mentioned preferable compounds, the interfacial barrier reduction layer may contain the thiophene derivative shown by the formula (1) and an arylamino compound, or may contain the arylphosphine oxide derivative shown by the formula (2) and an arylamino compound.

In the organic EL device of the invention, the organic layer between the anode and the cathode is not limited to the hole-injecting layer, the hole-transporting layer, the emitting layer, the electron-injecting layer and the electron-transporting layer shown in FIGS. 1A to 3B. The organic EL device of the invention may have a configuration shown by the following (1) to (8), and an interfacial barrier reduction layer may be provided between any two of the organic layers.
(1) Anode/hole-injecting layer/hole-transporting layer/emitting layer/electron-transporting layer/electron-injecting layer/cathode
(2) Anode/insulating layer/hole-transporting layer/emitting layer/electron-transporting layer/cathode
(3) Anode/hole-transporting layer/emitting layer/electron-transporting layer/insulating layer/cathode
(4) Anode/inorganic semiconductor layer/insulating layer/hole-transporting layer/emitting layer/insulating layer/cathode
(5) Anode/insulating layer/hole-transporting layer/emitting layer/electron-transporting layer/insulating layer/cathode
(6) Anode/hole-injecting layer/hole-transporting layer/emitting layer/electron-transporting layer/insulating layer/cathode
(7) Anode/insulating layer/hole-injecting layer/hole-transporting layer/emitting layer/electron-transporting layer/electron-injecting layer/cathode
(8) Anode/insulating layer/hole-injecting layer/hole-transporting layer/emitting layer/electron-transporting layer/electron-injecting layer/insulating layer/cathode

Each member constituting the organic EL device of the invention is described below.

### (Transparent Substrate)

The organic EL device of the invention is formed on a transparent substrate. The transparent substrate as referred to herein is a substrate for supporting the organic EL device, and is preferably a flat and smooth substrate having a transmittance of 50% or more for light rays within visible ranges of 400 to 700 nm.

Specific examples thereof include glass plates and polymer plates. Examples of the glass plate include soda-lime glass, barium/strontium-containing glass, lead glass, aluminosilicate glass, borosilicate glass, barium borosilicate glass, and quartz. Examples of the polymer plate include polycarbonate, acrylic polymer, polyethylene terephthalate, polyethersulfide, and polysulfone.

Transparency is not required when the supporting substrate is positioned in the direction opposite to the light-outcoupling direction.

### (Anode)

The anode plays a role for injecting holes into the hole-injecting layer, the hole-transporting layer or emitting layer. When transparency is required for the anode, indium tin oxide alloy (ITO), tin oxide (NESA), indium zinc oxide alloy (IZO), gold, silver, platinum, copper, and the like may be used as the material for the anode. When a reflective electrode which does not require transparency is used, a metal such as aluminum, molybdenum, chromium, and nickel or alloys thereof may also be used.

Although these materials may be used individually, alloys thereof or materials wherein another element is added to the materials can be appropriately selected for use.

The anode can be formed by forming these electrode materials into a thin film by vapor deposition, sputtering or the like.

In the case where emission from the emitting layer is taken out through the anode, the transmittance of the anode for the emission is preferably more than 10%. The sheet resistance of the anode is preferably several hundred Ω/□ or less. The film thickness of the anode, which varies depending upon the material thereof, is usually from 10 nm to 1 μm, preferably from 10 to 200 nm.

### (Emitting Layer)

The emitting layer has the following functions in combination.
(1) Injection function: function of allowing injection of holes from the anode or hole-injecting/transporting layer and injection of electrons from the cathode or electron-injecting/transporting layer upon application of an electric field
(2) Transporting function: function of moving injected carriers (electrons and holes) due to the force of an electric field
(3) Emitting function: function of allowing electrons and holes to recombine therein to emit light.

Note that electrons and holes may be injected into the emitting layer with different degrees, or the transportation capabilities indicated by the mobility of holes and electrons may differ. It is preferable that the emitting layer move either electrons or holes.

As the material used for the emitting layer, a known long-lived luminescent material may be used. It is preferable to use a material of the general formula (I) as the emitting material.

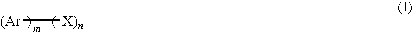

wherein Ar is an aromatic ring having 6 to 50 ring carbon atoms or a heteroaromatic ring having 5 to 50 atoms that form a ring (hereinafter referred to as “ring atoms”); X is a substituent; m is an integer of 1 to 5; and n is an integer of 0 to 6.

As specific examples of the aromatic ring and heteroaromatic ring shown by Ar, a phenyl ring, a naphthyl ring, an anthracene ring, a biphenylene ring, an azulene ring, an acenaphthylene ring, a fluorene ring, a phenanthrene ring, a fluoranthene ring, an acephenanthrylene ring, a triphenylene ring, a pyrene ring, a chrysene ring, a benzanthracene ring, a naphthacene ring, a picene ring, a perylene ring, a pentaphene ring, a pentacene ring, a tetraphenylene ring, a hexaphene ring, a hexacene ring, a rubicene ring, a coronene ring, a trinaphthylene ring, a pyrrole ring, an indole ring, a carbazole ring, an imidazole ring, a benzimidazole ring, an oxadiazole ring, a triazole ring, a pyridine ring, a quinoxaline ring, a quinoline ring, a pyrimidine ring, a triazine ring, a thiophene ring, a benzothiophene ring, a thianthrene ring, a furan ring, a benzofuran ring, a pyrazole ring, a pyrazine ring, a pyridazine ring, an indolizine ring, a quinazoline ring, a phenanthroline ring, a silole ring, a benzosilole ring, and the like can be given.

Ar is preferably a phenyl ring, a naphthyl ring, an anthracene ring, an acenaphthylene ring, a fluorene ring, a phenanthrene ring, a fluoranthene ring, a triphenylene ring, a pyrene ring, a chrysene ring, a benzanthracene ring, or a perylene ring.

Specific examples of the substituent represented by X include a substituted or unsubstituted aromatic group having 6 to 50 ring carbon atoms, a substituted or unsubstituted aromatic heterocyclic group having 5 to 50 ring atoms, a substituted or unsubstituted alkyl group having 1 to 50 carbon atoms, a substituted or unsubstituted alkoxy group having 1 to 50 carbon atoms, a substituted or unsubstituted aralkyl group having 1 to 50 carbon atoms, a substituted or unsubstituted aryloxy group having 5 to 50 ring atoms, a substituted or unsubstituted arylthio group having 5 to 50 ring atoms, a substituted or unsubstituted carboxyl group having 1 to 50 carbon atoms, a substituted or unsubstituted styryl group, a halogen group, a cyano group, a nitro group and a hydroxyl group.

Examples of the substituted or unsubstituted aromatic group having 6 to 50 ring carbon atoms include phenyl, 1-napthyl, 2-napthyl, 1-anthryl, 2-anthryl, 9-anthryl, 1-phenathryl, 2-phenanthryl, 3-phenanthryl, 4-phenanthryl, 9-phenanthryl, 1-naphthacenyl, 2-naphthacenyl, 9-nepthacenyl, 1-pyrenyl, 2-pyrenyl, 4-pyrenyl, 2-biphenylyl, 3-biphenylyl, 4-biphenylyl, p-terphenyl-4-yl, p-terpheneyl-3-yl, p-terphenyl-2-yl, m-terphenyl-4-yl, m-terphenyl-3-yl, m-terphenyl-2-yl, o-tolyl, m-tolyl, p-tolyl, p-t-buthylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, 2-fluorenyl, 9,9-dimethyl-2-fluorenyl and 3-fluoranthenyl.

Preferred examples include phenyl, 1-naphthyl, 2-naphthyl, 9-phenanthryl, 1-napthacenyl, 2-naphthacenyl, 9-naphthacenyl, 1-pyrenyl, 2-pyrenyl, 4-pyrenyl, 2-biphenylyl, 3-biphenylyl, 4-biphenylyl, o-tolyl, m-tolyl, p-tolyl, p-t-butylphenyl, 2-fluorenyl, 9,9-dimethyl-2-fluorenyl and 3-fluoranthenyl.

As examples of the substituted or unsubstituted aromatic heterocyclic group having 5 to 50 ring atoms, a 1-pyrrolyl group, 2-pyrrolyl group, 3-pyrrolyl group, pyrazinyl group, 2-pyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-isoindolyl group, 2-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiadinyl group, 2-phenothiadinyl group, 3-phenothiadinyl group, 4-phenothiadinyl group, 10-phenothiadinyl group, 1-phenoxadinyl group, 2-phenoxadinyl group, 3-phenoxadinyl group, 4-phenoxadinyl group, 10-phenoxadinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, 4-t-butyl-3-indolyl group, and the like can be given.

Examples of the substituted or unsubstituted alkyl group having 1 to 50 carbon atoms include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, 1,2,3-trinitropropyl, cyclopropyl, cyclobutyl, cyclopentyl, cyclohexyl, 4-methylcyclohexyl, 1-adamantyl, 2-adamantyl, 1-norbornyl and 2-norbornyl.

The substituted or unsubstituted alkoxy group having 1 to 50 carbon atoms are shown by —OY. Examples of Y include methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromoethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitoroisopropyl, 2,3-dinitro-t-butyl and 1,2,3-trinitropropyl.

Examples of the substituted or unsubstituted aralkyl group having 1 to 50 carbon atoms include benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-napthylmethyl, 1-β-napthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl and 1-chloro-2-phenylisopropyl.

The substituted or unsubstituted aryloxy group having 5 to 50 ring atoms is shown by —OY′. As examples of Y′, a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiadinyl group, 2-phenothiadinyl group, 3-phenothiadinyl group, 4-phenothiadinyl group, 1-phenoxadinyl group, 2-phenoxadinyl group, 3-phenoxadinyl group, 4-phenoxadinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butylpyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, 4-t-butyl-3-indolyl group, and the like can be given.

The substituted or unsubstituted arylthio group having 5 to 50 ring atoms is shown by —SY″. As examples of Y″, a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthrolin-2-yl group, 1,7-phenanthrolin-3-yl group, 1,7-phenanthrolin-4-yl group, 1,7-phenanthrolin-5-yl group, 1,7-phenanthrolin-6-yl group, 1,7-phenanthrolin-8-yl group, 1,7-phenanthrolin-9-yl group, 1,7-phenanthrolin-10-yl group, 1,8-phenanthrolin-2-yl group, 1,8-phenanthrolin-3-yl group, 1,8-phenanthrolin-4-yl group, 1,8-phenanthrolin-5-yl group, 1,8-phenanthrolin-6-yl group, 1,8-phenanthrolin-7-yl group, 1,8-phenanthrolin-9-yl group, 1,8-phenanthrolin-10-yl group, 1,9-phenanthrolin-2-yl group, 1,9-phenanthrolin-3-yl group, 1,9-phenanthrolin-4-yl group, 1,9-phenanthrolin-5-yl group, 1,9-phenanthrolin-6-yl group, 1,9-phenanthrolin-7-yl group, 1,9-phenanthrolin-8-yl group, 1,9-phenanthrolin-10-yl group, 1,10-phenanthrolin-2-yl group, 1,10-phenanthrolin-3-yl group, 1,10-phenanthrolin-4-yl group, 1,10-phenanthrolin-5-yl group, 2,9-phenanthrolin-1-yl group, 2,9-phenanthrolin-3-yl group, 2,9-phenanthrolin-4-yl group, 2,9-phenanthrolin-5-yl group, 2,9-phenanthrolin-6-yl group, 2,9-phenanthrolin-7-yl group, 2,9-phenanthrolin-8-yl group, 2,9-phenanthrolin-10-yl group, 2,8-phenanthrolin-1-yl group, 2,8-phenanthrolin-3-yl group, 2,8-phenanthrolin-4-yl group, 2,8-phenanthrolin-5-yl group, 2,8-phenanthrolin-6-yl group, 2,8-phenanthrolin-7-yl group, 2,8-phenanthrolin-9-yl group, 2,8-phenanthrolin-10-yl group, 2,7-phenanthrolin-1-yl group, 2,7-phenanthrolin-3-yl group, 2,7-phenanthrolin-4-yl group, 2,7-phenanthrolin-5-yl group, 2,7-phenanthrolin-6-yl group, 2,7-phenanthrolin-8-yl group, 2,7-phenanthrolin-9-yl group, 2,7-phenanthrolin-10-yl group, 1-phenazinyl group, 2-phenazinyl group, 1-phenothiadinyl group, 2-phenothiadinyl group, 3-phenothiadinyl group, 4-phenothiadinyl group, 1-phenoxadinyl group, 2-phenoxadinyl group, 3-phenoxadinyl group, 4-phenoxadinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrol-1-yl group, 2-methylpyrrol-3-yl group, 2-methylpyrrol-4-yl group, 2-methylpyrrol-5-yl group, 3-methylpyrrol-1-yl group, 3-methylpyrrol-2-yl group, 3-methylpyrrol-4-yl group, 3-methylpyrrol-5-yl group, 2-t-butyl-pyrrol-4-yl group, 3-(2-phenylpropyl)pyrrol-1-yl group, 2-methyl-1-indolyl group, 4-methyl-1-indolyl group, 2-methyl-3-indolyl group, 4-methyl-3-indolyl group, 2-t-butyl-1-indolyl group, 4-t-butyl-1-indolyl group, 2-t-butyl-3-indolyl group, 4-t-butyl-3-indolyl group, and the like can be given.

The substituted or unsubstituted carboxyl group having 1 to 50 carbon atoms is shown by —COOZ. As examples of Z, methyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cynoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl 1,2,3-trinitropropyl, and the like can be given.

Examples of the substituted or unsubstituted styryl group include 2-phenyl-1-vinyl, 2,2-diphenyl-1-vinyl and 1,2,2-triphenyl-1-vinyl.

Examples of the halogen group include fluorine, chlorine, bromine and iodine.

m is preferably 1 to 2. n is preferably 0 to 4. When m≧2, the Ars in the formula (I) may be independently the same or different. When n≧2, the Xs in the formula (I) may be independently the same or different.

In addition, as the material used in the emitting layer, an anthracene derivative represented by the following formula (II) can be given.

A¹-L-A² (II)

wherein A¹ and A² are independently a substituted or unsubstituted monophenylanthryl group or a substituted or unsubstituted diphenylanthryl group, and may be the same or different; and L is a single bond or a divalent linking group.

In addition to the anthracene derivative described above, an anthracene derivative represented by the formula (III) can be given.

A³-An-A⁴ (III)

wherein An is a substituted or unsubstituted divalent anthracene residue; and A³ and A⁴ are independently a substituted or unsubstituted monovalent condensed aromatic ring or a substituted or unsubstituted non-condensed ring aryl group having 12 or more carbon atoms and may be the same or different.

As preferable anthracene derivatives represented by the formula (II), anthracene derivatives represented by the formula (II-a) or the formula (II-b) can be given, for example.

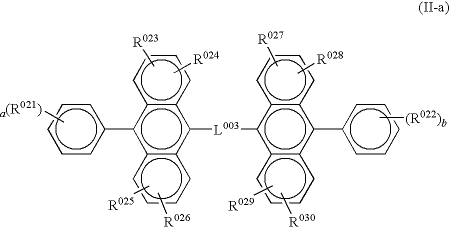

wherein R⁰²¹ to R⁰³⁰ are independently a hydrogen atom, an alkyl group, a cycloalkyl group, an aryl group which may be substituted, an alkoxy group, an aryloxy group, an alkylamino group, an alkenyl group, an arylamino group or a heterocyclic group which may be substituted; a and b are each an integer of 1 to 5; when they are 2 or more, R⁰²¹s or R⁰²²s may be the same or different, or R⁰²¹s or R⁰²²s may be bonded together to form a ring; R⁰²³ and R⁰²⁴, R⁰²⁵ and R⁰²⁶, R⁰²⁷ and R⁰²⁸, R⁰²⁹ and R⁰³⁰ may be bonded together to form a ring; and L⁰⁰³ is a single bond, —O—, —S—, —N(R)— (R is an alkyl group or an aryl group which may be substituted), an alkylene group or an arylene group.

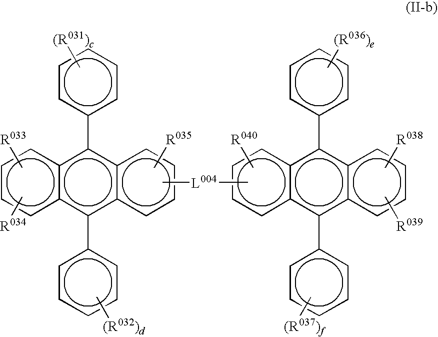

wherein R⁰³¹ to R⁰⁴⁰ are independently a hydrogen atom, an alkyl group, a cycloalkyl group, an aryl group, an alkoxyl group, an aryloxy group, an alkylamino group, an arylamino group or a heterocyclic group which may be substituted; c, d, e and f are each an integer of 1 to 5; when they are 2 or more, R⁰³¹s, R⁰³²s, R⁰³⁶s or R⁰³⁷s may be independently the same or different, R⁰³¹s, R⁰³²s, R⁰³³s or R⁰³⁷s may be bonded to each other to form a ring, R⁰³³ and R⁰³⁴, R⁰³⁹ and R⁰³⁸ may be bonded to each other to form a ring; and L⁰⁰⁴ is a single bond, —O—, —S—, —N(R)— (R is an alkyl group or a substituted or unsubstituted aryl group), an alkylene group or an arylene group.

As for R⁰²¹ to R⁰⁴⁰ shown in the above formulas (II-a) and (II-b), as the alkyl group, an alkyl group having 1 to 6 carbon atoms, as the cycloalkyl group, a cycloalkyl group having 3 to 6 carbon atoms, as the aryl group, an aryl group having 5 to 18 carbon atoms, as the alkoxy group, an alkoxy group having 1 to 6 carbon atoms, as the aryloxyl group, an aryloxy group having 5 to 18 carbon atoms, as the arylamino group, an amino group substituted with an aryl group having 5 to 16 carbon atoms, as the heterocyclic group, triazole, oxadiazole, quinoxaline, furanyl, thienyl or the like can preferably be given.

As the alkyl group and the aryl group shown by R in —N(R)— in L⁰⁰³ and L⁰⁰⁴, an alkyl group having 1 to 6 carbon atoms and an aryl group having 5 to 18 carbon atoms are preferable.

Also, a metal complex of 8-hydroxyquinoline or a derivative thereof is preferable.

As specific examples of the metal complex of 8-hydroxyquinoline and its derivative, metal chelate oxynoid compounds including a chelate of oxine (generally, 8-quinolinol or 8-hydroxyquinoline) can be given.

The emission performance of the emitting layer can be improved by adding a small amount of a fluorescent compound as a dopant therein. Although known emitting materials having a long lifetime may be used as the dopant, it is preferred that a material shown by the formula (IV) be used as a dopant material of the emitting material.

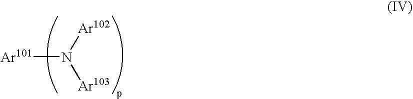

wherein Ar¹⁰¹ to Ar¹⁰³ are independently a substituted or unsubstituted aromatic group with 6 to 50 ring carbon atoms, or a substituted or unsubstituted styryl group.

As examples of the substituted or unsubstituted aromatic group having 6 to 50 ring carbon atoms, a phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-fluorenyl group, 9,9-dimethyl-2-fluorenyl group, 3-fluoranthenyl group, and the like can be given.

Of these, a phenyl group, 1-naphthyl group, 2-naphthyl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, o-tolyl group, m-tolyl group, p-tolyl group, p-t-butylphenyl group, 2-fluorenyl group, 9,9-dimethyl-2-fluorenyl group, 3-fluoranthenyl group, or the like are preferable.

As examples of the substituted or unsubstituted styryl group, a 2-phenyl-1-vinyl group, 2,2-diphenyl-1-vinyl group, 1,2,2-triphenyl-1-vinyl group or the like can be given.

p is an integer of 1 to 4. When p≧2, the Ar²s and Ar³s in the formula (IV) may be independently the same or different.

The following compounds are preferable as the dopant.

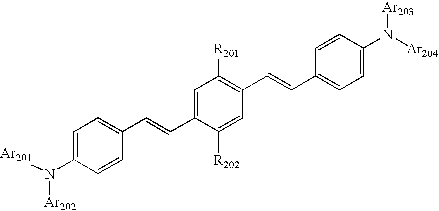

wherein Ar₂₀₁ to Ar₂₀₄ are independently a substituted or unsubstituted aryl group having 6 to 20 carbon atoms; and R₂₀₁ to R₂₀₂ are independently an alkyl group having 1 to 20 carbon atoms, a substituted or unsubstituted aryl group having 6 to 20 carbon atoms, hydrogen, halogen, cyano or trifluoromethyl.

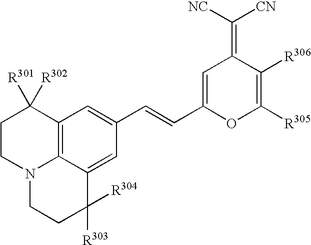

wherein R³⁰¹, R³⁰², R³⁰³, and R³⁰⁴ are independently alkyl having 1 to 10 carbon atoms; R³⁰⁵ is alkyl having 2 to 20 carbon atoms or sterically hindered aryl and heteroaryl; and R³⁰⁶is alkyl having 1 to 10 carbon atoms or a 5- or 6-membered carbocyclic ring connecting with R³⁰⁵.

For details, reference can be made to JP-A-10-308281.

### (Hole-Transporting/Hole-Injecting Layer)

The hole-transporting layer and the hole-injecting layer (hereinafter occasionally referred to as “hole-transporting layer”) are layers for helping the injection of holes into the emitting layer so as to transport holes to an emitting region. The hole-transporting layer and the hole-injecting layer have a large hole mobility and normally have a small ionization energy of 5.5 eV or less. As the hole-transporting layer, a material which can transport holes to the emitting layer at a lower electric field intensity is preferable. It is preferred that the hole mobility thereof be at least 10⁻⁴ cm²/V·sec when an electric field with an intensity of 10⁴ to 10⁶ V/cm, for example, is impressed.

In the invention, it is preferred that a layer containing the thiophene derivative represented by the above-mentioned formula (1) and a substance exhibiting electron acceptability for the thiophene derivative be formed in the hole-transporting region. In this case, the thiophene derivative and the electron-acceptable substance may be mixed with other materials. The other materials can be arbitrarily selected from materials which have been widely used as a material transporting carriers of holes and known materials used in a hole-injecting layer of EL devices.

Specific examples of materials for the hole-transporting layer include triazole derivatives (see U.S. Pat. No. 3,112,197 and others), oxadiazole derivatives (see U.S. Pat. No. 3,189,447 and others), imidazole derivatives (see JP-B-37-16096 and others), polyarylalkane derivatives (see U.S. Pat. Nos. 3,615,402, 3,820,989 and 3,542,544, JP-B-45-555 and 51-10983, JP-A-51-93224, 55-17105, 56-4148, 55-108667, 55-156953 and 56-36656, and others), pyrazoline derivatives and pyrazolone derivatives (see U.S. Pat. Nos. 3,180,729and 4,278,746, JP-A-55-88064, 55-88065, 49-105537, 55-51086, 56-80051, 56-88141, 57-45545, 54-112637 and 55-74546, and others), phenylene diamine derivatives (see U.S. Pat. No. 3,615,404, JP-B-51-10105, 46-3712 and 47-25336 and 54-119925, and others), arylamine derivatives (see U.S. Pat. Nos. 3,567,450, 3,240,597, 3,658,520, 4,232,103, 4,175,961 and 4,012,376, JP-B-49-35702 and 39-27577, JP-A-55-144250, 56-119132 and 56-22437, DE1,110,518, and others), amino-substituted chalcone derivatives (see U.S. Pat. No. 3,526,501, and others), oxazole derivatives (ones disclosed in U.S. Pat. No. 3,257,203, and others), styrylanthracene derivatives (see JP-A-56-46234, and others), fluorenone derivatives (JP-A-54-110837, and others), hydrazone derivatives (see U.S. Pat. No. 3,717,462, JP-A-54-59143, 55-52063, 55-52064, 55-46760, 57-11350, 57-148749 and 2-311591, and others), stilbene derivatives (see JP-A-61-210363, 61-228451, 61-14642, 61-72255, 62-47646, 62-36674, 62-10652, 62-30255, 60-93455, 60-94462, 60-174749 and 60-175052, and others), silazane derivatives (U.S. Pat. No. 4,950,950), polysilanes (JP-A-2-204996) aniline copolymers (JP-A-2-282263), and electroconductive high molecular oligomers (in particular thiophene oligomers)

In addition to the hole-transporting layer, it is preferred that a hole-injecting layer be separately provided to help the injection of holes. As the material for the hole-injecting layer, the same substances used for the hole-transporting layer can be used. The following can also be used: porphyrin compounds (ones disclosed in JP-A-63-295695 and others), aromatic tertiary amine compounds and styrylamine compounds (see U.S. Pat. No. 4,127,412, JP-A-53-27033, 54-58445, 55-79450, 55-144250, 56-119132, 61-295558, 61-98353 and 63-295695, and others). Aromatic tertiary amine compounds are particularly preferably used.

The following can also be given as examples: 4,4′-bis(N-(1-naphthyl)-N-phenylamino)biphenyl (abbreviated by NPD, hereinafter), which has in the molecule thereof two condensed aromatic rings, disclosed in U.S. Pat. No. 5,061,569, and 4,4′,4″-tris(N-(3-methylphenyl)-N-phenylamino)triphenylamine (abbreviated by MTDATA, hereinafter) wherein three triphenylamine units are linked to each other in a star-burst form, disclosed in JP-A-4-308688.

Inorganic compounds such as p-type Si and p-type SiC as well as aromatic dimethylidene type compounds can also be used as the material of the hole-injecting layer.

The film thickness of the hole-transporting layer is not particularly limited, and is usually from 5 nm to 5 μm. This hole-transporting layer may be a single layer made of one or two or more of the above-mentioned materials, or may be stacked hole-transporting layers made of different compounds.

An organic semiconductor layer is one type of a hole-transporting layer for helping the injection of holes or electrons into an emitting layer, and is preferably a layer having an electric conductivity of 10⁻¹⁰ S/cm or more. As the material of such an organic semiconductor layer, electroconductive oligomers such as thiophene-containing oligomers or arylamine-containing oligomers disclosed in JP-A-8-193191, and electroconductive dendrimers such as arylamine-containing dendrimers may be used.

### (Electron-Injecting/Electron-Transporting Layer)

The electron-transporting layer and the electron-injecting layer (hereinafter occasionally referred to as “an electron-transporting layer”) are layers which assist injection of electrons into the emission layer, and exhibit a high electron mobility. An adhesion-improving layer is one type of the electron-transporting layer formed of a material which exhibits particularly excellent adhesion to the cathode. The material used in the electron-transporting layer is preferably a metal complex of 8-hydroxyquinoline or a derivative thereof.

As specific examples of a metal complex of 8-hydroxyquinoline or an 8-hydroxyquinoline derivative, metal chelate oxynoid compounds including a chelate of oxine (generally, 8-quinolinol or 8-hydroxyquinoline) can be given.

For example, Alq described as the emitting material can be used for the electron-transporting layer.

An electron-transmitting compound of the following formula can be given as the oxadiazole derivative.

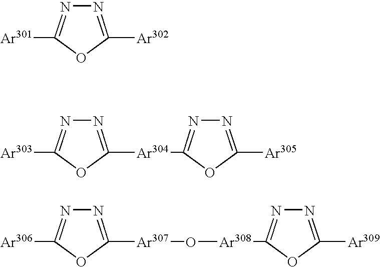

wherein Ar³⁰¹, Ar³⁰², Ar³⁰³, Ar³⁰⁵, Ar³⁰⁶ and Ar³⁰⁹ are independently a substituted or unsubstituted aryl group; and Ar³⁰⁴, Ar³⁰⁷ and Ar³⁰⁸ are independently a substituted or unsubstituted arylene group.

As examples of the aryl group, a phenyl group, a biphenyl group, an anthranyl group, a perylenyl group, and a pyrenyl group can be given. As examples of the arylene group, a phenylene group, a naphthylene group, a biphenylene group, an anthranylene group, a perylenylene group, a pyrenylene group, and the like can be given. As the substituent, an alkyl group having 1 to 10 carbon atoms, an alkoxy group having 1 to 10 carbon atoms, a cyano group, and the like can be given. The electron-transmitting compound is preferably one from which a thin film can be formed.

The following compounds can be given as specific examples of the electron-transmitting compound.

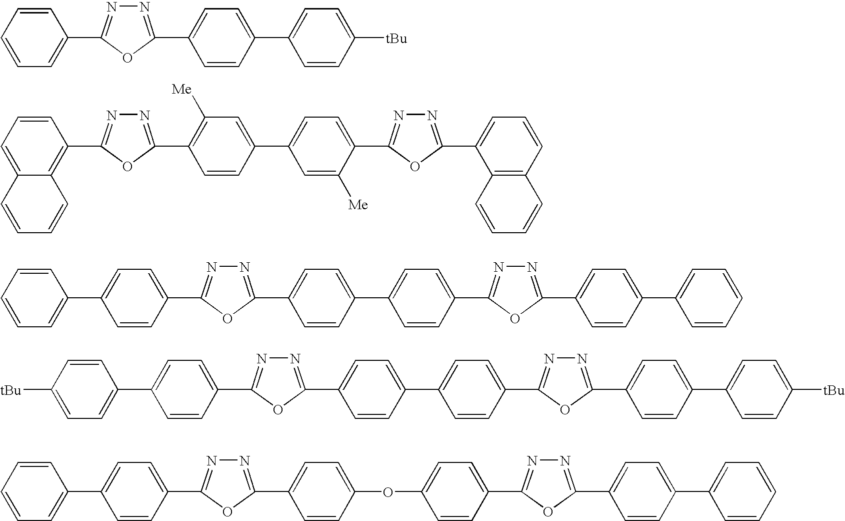

The following compounds are also preferable.

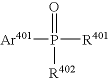

wherein R⁴⁰¹ and R⁴⁰² are independently a hydrogen atom, an alkyl group, a cycloalkyl group, an aralkyl group, an alkenyl group, a cycloalkenyl group, an alkynyl group, an alkoxy group, an alkylthio group, an arylether group, an arylthioether group, an aryl group, a heterocyclic group, a halogen atom, a cyano group, an aldehyde group, a carbonyl group, a carboxyl group, an amino group, a nitro group, a silyl group, or a condensed ring formed by bonding of adjacent substituents; and Ar⁴⁰¹ is an aryl group.

A preferred embodiment of the invention is a device containing a reducing dopant in an electron-transporting region or in an interfacial region between the cathode and the organic layer. The reducing dopant is defined as a substance which can reduce an electron-transporting compound. Accordingly, various substances which have given reducing properties can be used. For example, at least one substance can be preferably used which is selected from the group consisting of alkali metals, alkaline earth metals, rare earth metals, alkali metal oxides, alkali metal halides, alkaline earth metal oxides, alkaline earth metal halides, rare earth metal oxides, rare earth metal halides, alkali metal organic complexes, alkaline earth metal organic complexes, and rare earth metal organic complexes.

More specific examples of the preferred reducing dopants include at least one alkali metal selected from the group consisting of Na (work function: 2.36 eV), K (work function: 2.28 eV), Rb (work function: 2.16 eV) and Cs (work function: 1.95 eV), and at least one alkaline earth metal selected from the group consisting of Ca (work function: 2.9 eV), Sr (work function: 2.0 to 2.5 eV), and Ba (work function: 2.52 eV). Metals having a work function of 2.9 eV or less are particularly preferred.

Among these, a more preferable reducing dopant is at least one alkali metal selected from the group consisting of K, Rb and Cs. Even more preferable is Rb or Cs. Most preferable is Cs.

These alkali metals are particularly high in reducing ability. Thus, the addition of a relatively small amount thereof to an electron-injecting zone improves the luminance of the organic EL device and make the lifetime thereof long. As a reducing dopant having a work function of 2.9 eV or less, combinations of two or more alkali metals among these are preferable, particularly combinations including Cs, such as Cs and Na, Cs and K, Cs and Rb, or Cs, Na and K are preferable.

The combination containing Cs makes it possible to exhibit the reducing ability efficiently. The luminance of the organic EL device can be improved and the lifetime thereof can be made long by the addition thereof to its electron-injecting zone.

In the invention, an electron-injecting layer made of an insulator or a semiconductor may further be provided between a cathode and an organic layer. By forming the electron-injecting layer, a current leakage can be effectively prevented and electron-injecting properties can be improved.

As the insulator, at least one metal compound selected from the group consisting of alkali metal calcogenides, alkaline earth metal calcogenides, halides of alkali metals and halides of alkaline earth metals can be preferably used. When the electron-injecting layer is formed of the alkali metal calcogenide or the like, the injection of electrons can be preferably further improved.

Specifically preferable alkali metal calcogenides include Li₂O, LiO, Na₂S, Na₂Se and NaO and preferable alkaline earth metal calcogenides include CaO, BaO, SrO, BeO, BaS and CaSe. Preferable halides of alkali metals include LiF, NaF, KF, LiCl, KCl and NaCl. Preferable halides of alkaline earth metals include fluorides such as CaF₂, BaF₂, SrF₂, MgF₂ and BeF₂ and halides other than fluorides.

Semiconductors forming an electron-transporting layer include one or combinations of two or more of oxides, nitrides, and oxidized nitrides containing at least one element of Ba, Ca, Sr, Yb, Al, Ga, In, Li, Na, Cd, Mg, Si, Ta, Sb and Zn.

An inorganic compound forming an electron-transporting layer is preferably a microcrystalline or amorphous insulating thin film. When the electron-transporting layer is formed of the insulating thin films, more uniformed thin film is formed whereby pixel defects such as a dark spot are decreased.

Examples of such an inorganic compound include the above-mentioned alkali metal calcogenides, alkaline earth metal calcogenides, halides of alkali metals, and halides of alkaline earth metals.

### (Cathode)

For the cathode, the following may be used: an electrode substance made of a metal, an alloy, an electroconductive compound, and a mixture thereof which has a small work function (for example, 4 eV or less). Specific examples of the electrode substance include sodium, sodium-potassium alloy, magnesium, lithium, magnesium/silver alloy, aluminum/aluminum oxide, aluminum/lithium alloy, indium, and rare earth metals.

This cathode can be formed by making the electrode substances into a thin film by vapor deposition, sputtering or some other method.

In the case where light is outcoupled from the emitting layer through the cathode, the cathode preferably has a light transmittance of larger than 10%.

The sheet resistance of the cathode is preferably several hundred Ω/□ or less, and the film thickness thereof is usually from 10 nm to 1 μm, preferably from 50 to 200 nm.

### (Insulating Layer)

In the organic EL device, pixel defects based on leakage or a short circuit are easily generated since an electric field is applied to the ultrathin film. In order to prevent this, it is preferred to insert an insulative thin layer between the pair of electrodes.

Examples of the material used in the insulating layer include aluminumoxide, lithium fluoride, lithiumoxide, cesium fluoride, cesium oxide, magnesium oxide, magnesium fluoride, calcium oxide, calcium fluoride, cesium fluoride, cesium carbonate, aluminum nitride, titanium oxide, silicon oxide, germanium oxide, silicon nitride, boron nitride, molybdenum oxide, ruthenium oxide, and vanadium oxide.

A mixture or laminate thereof may be used.

### (Fabricating Example of the Organic EL Device)

By using the materials and the method described above, the organic EL device can be fabricated by forming an anode, organic layers and a cathode in this order. The organic EL device can be fabricated in the order reverse to the above, i.e., the order from a cathode to an anode.

An example of the fabrication of the organic EL device will be described below wherein the following layers are successively formed on a transparent substrate: anode/hole-transporting layer/emitting layer/electron-transporting layer/cathode.

First, a thin film made of an anode material is formed into a thickness of 1 μm or less, preferably 10 to 200 nm on an appropriate transparent substrate by vapor deposition, sputtering or some other method, thereby forming an anode.

Next, a hole-transporting layer is formed on this anode. As described above, the hole-transporting layer can be formed by vacuum vapor deposition, spin coating, casting, LB technique, or some other method. Vacuum vapor deposition is preferred since a homogenous film is easily obtained and pinholes are not easily generated.

In the case where the hole-transporting layer is formed by vacuum vapor deposition, conditions for the deposition vary depending upon a compound used (a material for the hole-transporting layer), a desired crystal structure or recombining structure of the hole-transporting layer, and others. In general, the conditions are preferably selected from the following: deposition source temperature of 50 to 450° C., vacuum degree of 10⁻⁷ to 10⁻³ torr, deposition rate of 0.01 to 50 nm/second, substrate temperature of −50 to 300° C., and film thickness of 5 nm to 5 μm.

Next, an emitting layer is formed on the hole-transporting layer. The emitting layer can also be formed by making a desired organic emitting material into a thin film by vacuum vapor deposition, sputtering, spin coating, casting or some other method. Vacuum vapor deposition is preferred since a homogenous film is easily obtained and pinholes are not easily generated. In the case where the emitting layer is formed by vacuum vapor deposition, conditions for the deposition, which vary depending on a compound used, can be generally selected from conditions similar to those for the hole-transporting layer.

Next, an electron-transporting layer is formed on this emitting layer. Like the hole-transporting layer and the emitting layer, the layer is preferably formed by vacuum vapor deposition because a homogenous film is required. Conditions for the deposition can be selected from conditions similar to those for the hole-transporting layer and the emitting layer.

Lastly, a cathode is stacked thereon to obtain an organic EL device.

The cathode is made of a metal, and vapor deposition or sputtering may be used. However, vapor vacuum deposition is preferred in order to protect underlying organic layers from being damaged when the cathode film is formed.

For the organic EL device fabrication that has been described above, it is preferred that the formation from the anode to the cathode is continuously carried out, using only one vacuuming operation.

The method for forming each of the layers in the organic EL device of the invention is not particularly limited. The layers can be formed by a known method such as vacuum vapor deposition, molecular beam epitaxy (MBE), or an applying method using a solution in which the material is dissolved in a solvent, such as dipping, spin coating, casting, bar coating, or roll coating.

The film thickness of each of the organic layers in the organic EL device of the invention is not particularly limited. In general, defects such as pinholes are easily generated when the film is too thin. Conversely, when the film is too thick, a high applied voltage becomes necessary, leading to low efficiency. Usually, the film thickness is preferably in the range of several nanometers to one micrometer.

### EXAMPLES

The invention is described below in detail by the following examples. The structure of each of the compounds used in Examples and Comparative Examples is shown below.

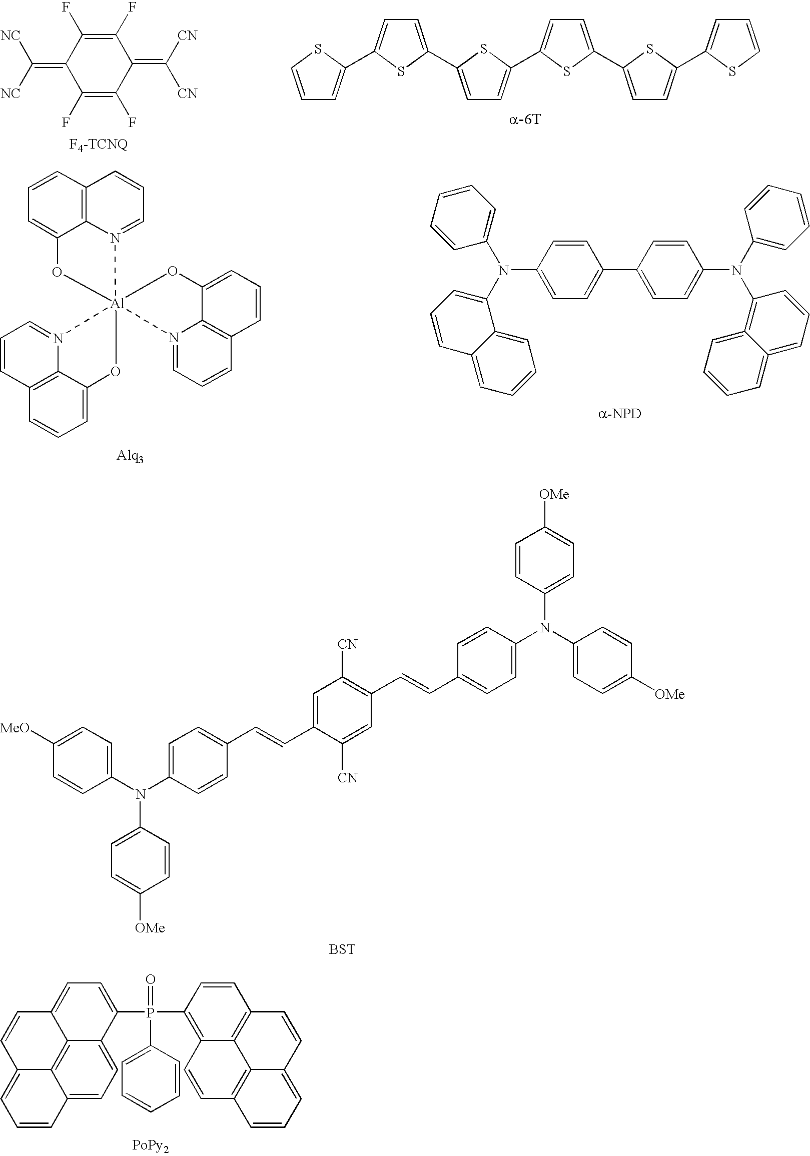

### Example 1

In Example 1, an organic EL device with the following configuration was fabricated.
Anode: ITO (110 nm)
Hole-transporting layer: α-NPD (35 nm)
Interfacial barrier reduction layer: 50% NPD-doped POPy₂ (5 nm)
Emitting layer: 0.5% BST-doped POPy₂ (20 nm)
Interfacial barrier reduction layer: 50% α-POPy₂-doped Alq₃ (5 nm)
Electron-transporting layer: Alq₃ (25 nm)
Electron-injecting electrode: LiF (0.5 nm)
Metal electrode: Al (100 nm)

A glass substrate of 25 mm by 75 mm by 1.1 mm thick with ITO transparent electrode lines (110 nm) (GEOMATEC CO., LTD.) was subjected to ultrasonic cleaning with isopropyl alcohol for 5 minutes, and cleaned with ultraviolet rays and ozone for 30 minutes. The resultant substrate with transparent electrode lines was mounted on a substrate holder in a vacuum deposition device. First, a 35 nm-thick α-NPD was formed so as to cover the surface of the transparent electrode on which the transparent electrode lines were formed. This α-NPD film functioned as a hole-transporting layer. Subsequent to the formation of the hole-transporting layer, α-NPD and POPy₂ were co-deposited in a film thickness of 5 nm by resistance heating such that the concentration of α-NPD became 50 mol %. The resulting film functioned as an interfacial barrier reduction layer. On the resulting film, POPy₂ as a host material and BST as a dopant were co-deposited in a film thickness of 20 nm by resistance heating such that the concentration of BST became 0.5 mol %. The resulting film functioned as an emitting layer. Subsequently, POPy₂ and Alq₃ were co-deposited in a film thickness of 5 nm by resistance heating such that the concentration of POPy₂ became 50 mol %. The resulting film functioned as an interfacial barrier reduction layer. Furthermore, Alq₃ were formed in a thickness of 25 nm. The resulting film functioned as an electron-transporting layer. Thereafter, as an electron-injecting electrode (cathode), LiF was formed in a thickness of 0.5 nm at a film-forming speed of 1 Å/min. A metal Al film was deposited on this LiF layer to form a metal cathode in a film thickness of 100 nm, whereby an organic EL device was fabricated.

### Example 2

In Example 2, an organic EL device with the following configuration was fabricated.
Anode: ITO (110 nm)
Hole-injecting layer: α-6T (20 nm)
Interfacial barrier reduction layer: 50 % α-6T-doped α-NPD (5 nm)
Hole-transporting layer: α-NPD (10 nm)
Interfacial barrier reduction layer: 50% α-NPD-doped POPy₂ (5 nm)
Emitting layer: 0.5% BST-doped POPy₂ (20 nm)
Electron-transporting layer: POPy₂ (30 nm)
Electron-injecting electrode: LiF (0.5 nm)
Metal electrode: Al (100 nm)

In the same manner as in Example 1, on a glass substrate with ITO transparent electrode lines, a 20 nm-thick α-6 T film (hole-injecting layer), a5 nm-thick α-NPD film in which 50mol % of α-6T was doped (interfacial barrier reduction layer), a 10 nm-thick α-NPD film (hole-transporting layer), a 5 nm-thick POPy₂ film in which 50 mol % of α-NPD was doped (interfacial barrier reduction layer), a 20 nm-thick POPy₂ film in which 0.5 mol % of BST was doped (emitting layer), a 30 nm-thick POPy₂ film (electron-transporting layer), a 0.5 nm-thick LiF film (electron-injecting electrode (cathode)) and a 100 nm-thick metal Al film (metal cathode) were formed in sequence, whereby an organic EL device was fabricated.

### Comparative Example 1

In Comparative Example 1, an organic EL device with the following configuration was fabricated.
Anode: ITO (110 nm)
Hole-transporting layer: α-NPD (40 nm)
Emitting layer: 0.5% BST-doped POPy₂ (20 nm)
Electron-transporting layer: Alq₃ (30 nm)

Electron-injecting electrode: LiF (0.5 nm)

Metal electrode: Al (100 nm)

An organic EL device was fabricated in the same manner as in Example 1, except that, in Example 1, the α-NPD-doped POPy₂ interfacial barrier reduction layer and the POPy₂-doped Alq₃ interfacial barrier reduction layer were not formed, the thickness of the hole-transporting layer was changed to 40 nm and the thickness of the electron-transporting layer was changed to 30 nm.

### Comparative Example 2

In Comparative Example 2, an organic EL device with the following configuration was fabricated.
Anode: ITO (110 nm)
Hole-injecting layer: α-6 T (20 nm)
Hole-transporting layer: α(-NPD (20 nm)
Emitting layer: 0.5 % BST-doped POPy₂ (20 nm)
Electron-transporting layer: POPy₂ (30 nm)
Electron-injecting electrode: LiF (0.5 nm)
Metal electrode: Al (100 nm)

An organic EL device was fabricated in the same manner as in Example 2, except that, in Example 2, the α-6 T-doped α-NPD interfacial barrier reduction layer and the α-NPD-doped POPy₂ interfacial barrier reduction layer were not formed and the thickness of the hole-transporting layer was changed to 20 nm.

### (Evaluation of the Light-Emitting Performance of the Organic EL Device)

The organic EL devices fabricated in Examples 1 and 2 and Comparative Examples 1 and 2 were caused to emit light by DC driving, and the luminance (L) and the current density were measured to obtain a luminous efficiency and an external quantum efficiency.

The driving voltage, luminous efficiency and external quantum efficiency when the current density was 100 mA/cm² are shown in Table 1.

TABLE 1

| | | Luminous | External |
|---|---|---|---|
| | Driving voltage | efficiency | quantum |
| | (V) | (lm/W) | efficiency (%) |
| Example 1 | 6.8 | 2.7 | 1.6 |
| Example 2 | 3.6 | 5.6 | 1.7 |
| Com. Ex. 1 | 7.7 | 1.9 | 1.3 |
| Com. Ex. 2 | 4.5 | 4.2 | 1.7 |

### Example 3

In Example 3, an organic EL device with the following configuration was fabricated.
Anode: ITO (110 nm)
Hole-injecting layer: 50% α-6 T-doped F₄TCNQ (5 nm)
Interfacial barrier reduction layer: 50% α-6 T-doped α-NPD (5 nm)
Hole-transporting layer: α-NPD (40 nm)
Emitting layer, electron-transporting layer: Alq₃ (50 nm)
Electron-injecting electrode: LiF (0.5 nm)
Metal electrode: Al (70 nm)

In the same manner as in Example 1, on a glass substrate with ITO transparent electrode lines, a 5 nm-thick F4TCNQ film in which 50 mol % of α-6 T was doped (hole-injecting layer), a 5 nm-thick α-NPD film in which 50 mol % of α-6 T was doped (interfacial barrier reduction layer), a 40 nm-thick α-NPD film (hole-transporting layer), a 50 nm-thick Alq₃ film (emitting layer, electron-transporting layer), a 0.5 nm-thick LiF film (electron-injecting electrode (cathode)) and a 70 nm-thick metal Al film (metal cathode) were formed in sequence, whereby an organic EL device was fabricated.

The driving voltage at a current density of 100 mA/cm² was 11.4 V.

### Example 4

In Example 4, an organic EL device with the following configuration was fabricated.
Anode: ITO (110 nm)
Hole-injecting layer: 3% α-6 T-doped F₄ TCNQ (5 nm)
Interfacial barrier reduction layer: 50% α-6 T-doped α-NPD (5 nm)
Hole-transporting layer: α-NPD (40 nm)
Emitting layer, electron-transporting layer: Alq₃ (50 nm)
Electron-injecting electrode: LiF (0.5 nm)
Metal electrode: Al (70 nm)

An organic EL device was fabricated in the same manner as in Example 3, except that, in Example 3, the concentration of α-6 T in the hole-injecting layer was changed to 3 mol %.

The driving voltage at a current density of 100 mA/cm² was 12.4 V.

### Example 5

In Example 5, an organic EL device with the following configuration was fabricated.
Anode: ITO (110 nm)
Hole-injecting layer: 3% α-6 T-doped F₄ TCNQ (5 nm)
Interfacial barrier reduction layer: 50% α-6 T-doped α-NPD (5 nm)
Hole-transporting layer: α-NPD (40 nm)
Emitting layer: Alq₃ (50 nm)
Hole-transporting layer: 30% POPy₂-doped Cs (20 nm)
Metal electrode (cathode): Al (70 nm)

An organic EL device was fabricated in the same manner as in Example 3, except that, in Example 3, the concentration of α-6 T in the hole-injecting layer was changed to 3 mol %, a 20 nm-thick Cs film in which 30 mol % of POPy₂ was doped was formed as the electron-transporting layer, and an LiF film as the electron-injecting electrode was not formed.

The driving voltage at a current density of 100 mA/cm² was 8.4 V.

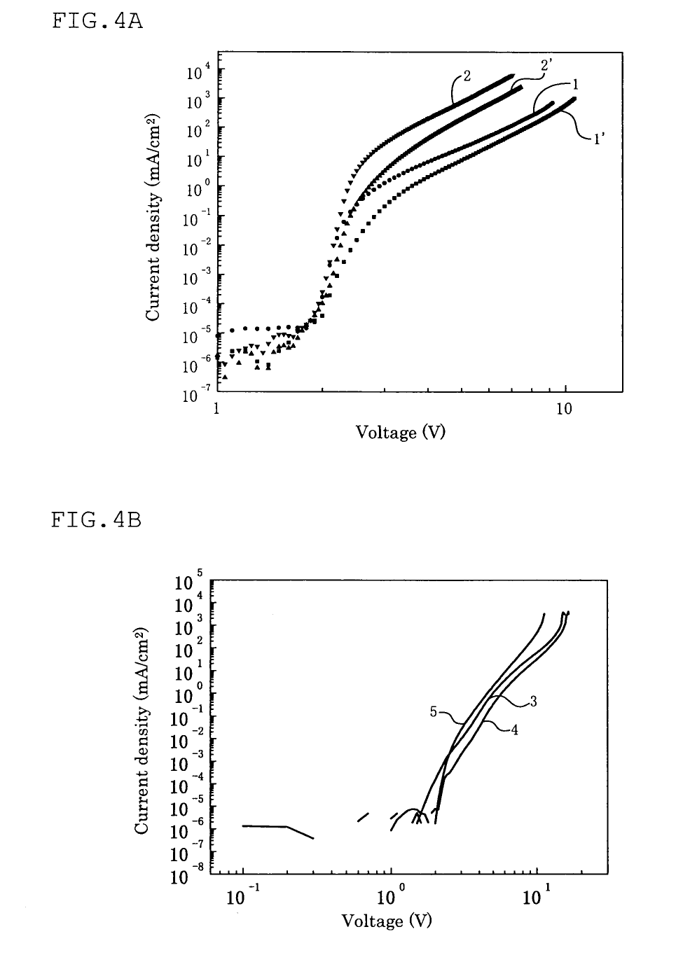

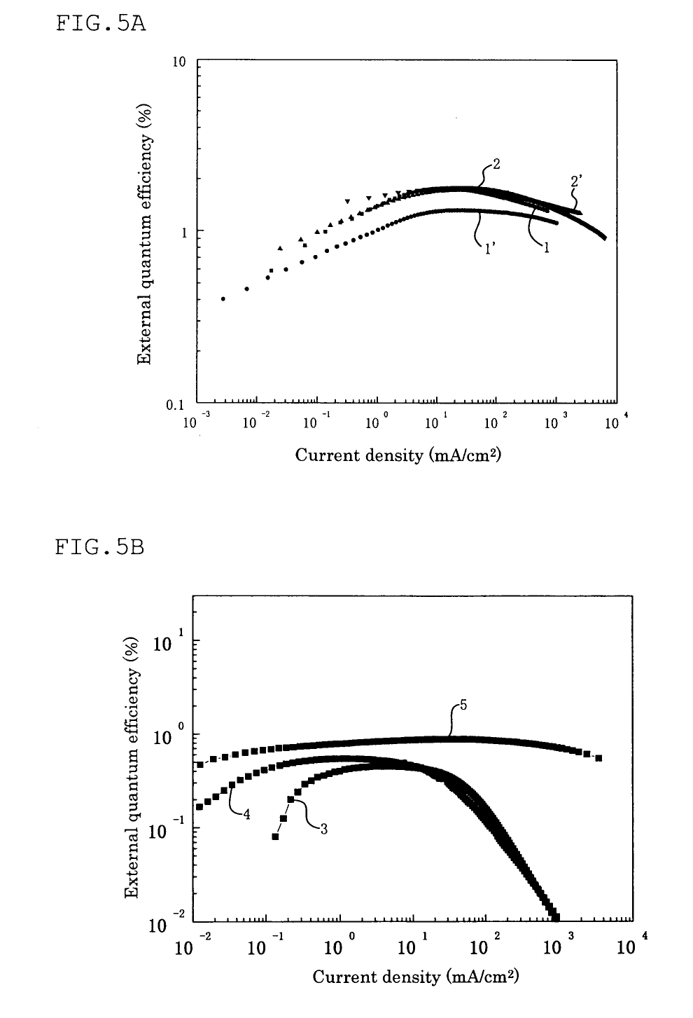

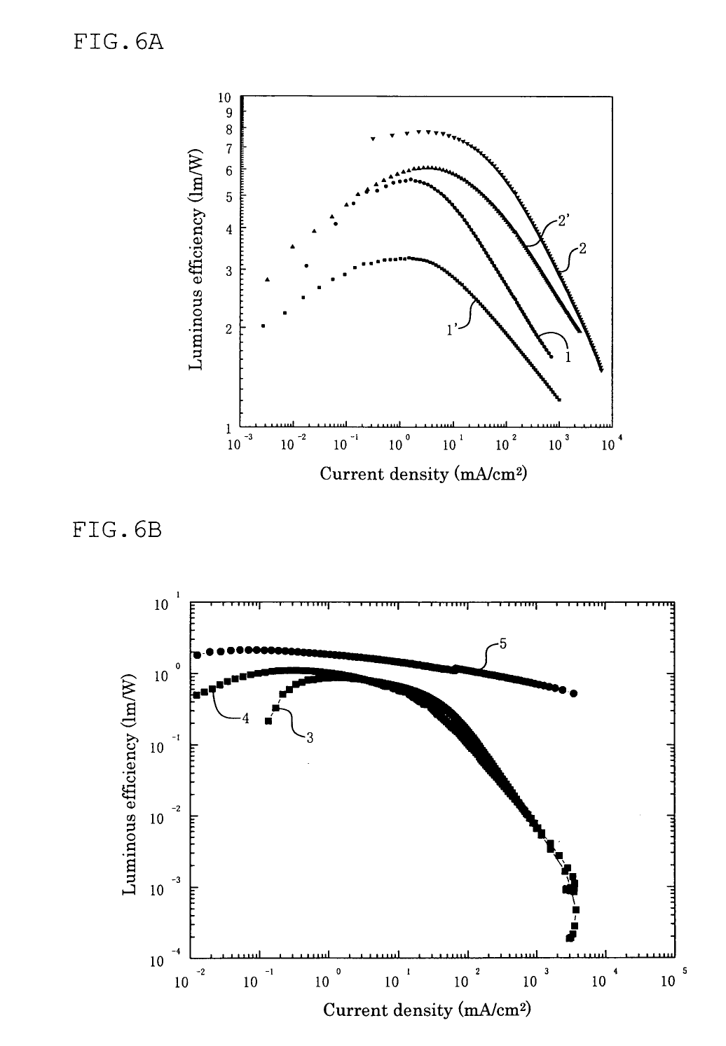

FIG. 4A is a graph showing current density-voltage characteristics of the organic EL devices fabricated in Examples 1 and 2 and Comparative Examples 1 and 2, FIG. 4B is a graph showing current density-voltage characteristics of the organic EL devices fabricated in Examples 3 to 5, FIG. 5A is a graph showing external quantum efficiency-current density characteristics of the organic EL devices fabricated in Examples 1 and 2 and Comparative Examples 1 and 2, FIG. 5B is a graph showing external quantum efficiency-current density characteristics of the organic EL devices fabricated in Examples 3 to 5, FIG. 6A is a graph showing luminous efficiency-current density characteristics of the organic EL devices fabricated in Examples 1 and 2 and Comparative Examples 1 and 2, and FIG. 6B is a graph showing luminous efficiency-current density characteristics of the organic EL devices fabricated in Examples 3 to 5.

In the graphs given in FIGS. 4A, 5A and 6A, 1 indicates the characteristics of Example 1, 2 indicates the characteristics of Example 2, 1′ indicates the characteristics of Comparative Example 1 and 2′ indicates the characteristics of Comparative Example 2. In the graphs given in FIGS. 4B, 5B and 6B, 3 indicates the characteristics of Example 3, 4 indicates the characteristics of Example 4 and 5 indicates the characteristics of Example 5.

As apparent from the above, it was confirmed that the organic EL devices of Examples were excellent devices which could be driven at a low voltage and had a high luminous efficiency or external quantum efficiency, since they have better carrier injection properties than the organic EL devices fabricated in Comparative Examples.

### INDUSTRIAL APPLICABILITY

The organic EL device of the invention can be suitably used as a light source such as a planar emitting material and backlight of a display, a display part of a portable phone, PDA, a car navigation system, or an instrument panel of an automobile, an illuminator, and the like.

The contents of the above-mentioned documents are herein incorporated by reference in its entirety.

1. An organic electroluminescence device comprising:
an anode and a cathode;
two or more organic layers including an emitting layer between the anode and the cathode, the organic layers including, between the anode and the emitting layer, a hole-injecting layer or a hole-transporting layer which contains a thiophene derivative having a molecular weight of 1,200 or less; and
an interfacial barrier reduction layer being between two adjacent organic layers selected from the organic layers, the interfacial barrier reduction layer containing a mixture of at least one material contained in one of the two adjacent organic layers and at least one material contained in the other of the two adjacent organic layers at a molar ratio of 1:1 to 1:4.

2. The organic electroluminescence device according to claim 1, wherein the hole-injecting layer, the hole-transporting layer or the interfacial barrier reduction layer adjacent to the hole-injecting layer or the hole-transporting layer contains an electron-accepting compound together with the thiophene derivative.

3. The organic electroluminescence device according to claim 2, wherein the electron-accepting compound contains a cyano group.

4. The organic electroluminescent device according to claim 1, wherein the thiophene derivative is a thiophene derivative shown by the following formula (1): 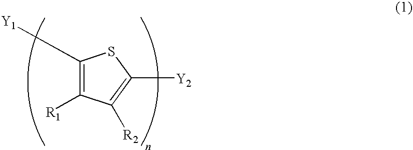
wherein R₁ and R₂ are independently a hydrogen atom, a halogen atom, a cyano group, an alkyl group having 1 to 20 carbon atoms, a haloalkyl group having 1 to 20 carbon atoms, an alkoxy group having 1 to 20 carbon atoms, an arylamino group having 6 to 40 carbon atoms, a substituted or unsubstituted aryl group having 6 to 40 ring carbon atoms or a substituted or unsubstituted heterocyclic group having 2 to 40 ring carbon atoms, and adjacent substituents maybe bonded to each other to form a ring; Y₁ and Y₂ are independently a hydrogen atom or a substituted or unsubstitued monovalent group; and n is an integer of 1 to 12, provided that when n is 2 or more, R₁s and R₂s may be independently the same or different.

5. The organic electroluminescence device arroding to claim 4, wherein Y₁ and Y₂ in the formula (1) are independently a hydrogen atom, an alkyl group having 1 to 20 carbon atoms, a substituted or unsubstituted aryl group having 6 to 40 ring carbon atoms or a substituted or unsubstituted heterocyclic group having 2 to 40 ring carbon atoms.

6. An organic electroluminescence device comprising:
an anode and a cathode;
two or more organic layers including an emitting layer between the anode and the cathode, the emitting layer or a layer present between the emitting layer and the cathode containing an arylphosphine oxide derivative shown by the following formula (2); and
an interfacial barrier reduction layer being between two adjacent organic layers selected from the organic layers, the interfacial barrier reduction layer containing a mixture of at least one material contained in one of the two adjacent organic layers and at least one material contained in the other of the two adjacent organic layers: 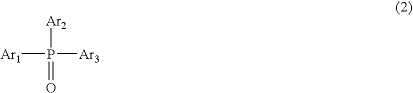
wherein Ar₁, Ar₂ and Ar₃ are independently an aromatic hydrocarbon group having 6 to 20 carbon atoms.

7. The organic electroluminescence device according to claim 1, wherein the interfacial barrier reduction layer contains all the materials contained in both the adjacent organic layers.

8. The organic electroluminescent device accroding to claim 1, wherein the organic layers contain a hole-transporting layer between the anode and the emitting layer, the interfacial barrier reduction layer is between the emitting layer and the hole-transporing layer and contains an emitting material contained in the emitting layer and a hole-transporing material contained in the hole-transporing layer.

9. The organic electroluminescence device according to claim 1, wherein the organic layers include a hole-transporting layer and a hole-injecting layer between the anode and the emitting layer, and the interfacial barrier reduction layer is between the hole-injecting layer and the hole-transporting layer and contains a hole-injecting material contained in the hole-injecting layer and a hole-transporting material contained in the hole-transporting layer.

10. The organic electroluminescence device according to claim 1, wherein the organic layers include an electron-transporting layer between the cathode and the emitting layer, and the interfacial barrier reduction layer is between the emitting layer and the electron-transporting layer and contains an emitting material contained in the emitting layer and an electron-transporting material contained in the electron-transporting layer.

11. The organic electroluminescence device according to claim 1, wherein the organic layers include an electron-transporting layer and an electron-injecting layer between the cathode and the emitting layer and the interfacial barrier reduction layer is between the electron-injecting layer and the electron-transporting layer and contains an electron-injecting material contained in the electron-injecting layer and an electron-transporting material contained in the electron-transporting layer.

12. The organic electroluminescence device according to claim 9, wherein the hole-injecting material or the hole-transporting material is an arylamino compound.

13. The organic electroluminescence device according to claim 1, wherein the interfacial barrier reduction layer contains a thiophene derivative shown by the following formula (1) and an arylamino compound: 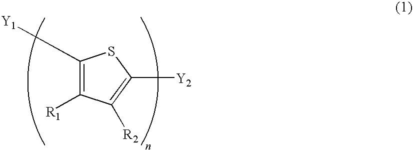
wherein R₁ and R₂ are independently a hydrogen atom, a halogen atom, a cyano group, an alkyl group having 1 to 20 carbon atoms, a haloalkyl group having 1 to 20 carbon atoms, an alkoxy group having 1 to 20 carbon atoms, an arylamino group having 6 to 40 carbon atoms, a substituted or unsubstituted aryl group having 6 to 40 ring carbon atoms or a substituted or unsubstituted heterocyclic group having 2 to 40 ring carbon atoms, and adjacent substitutents may be bonded to each other to form a ring; Y₁ and Y₂ are independently a hydrogen atom or a substituted or unsubstituted monovalent group; and n is an integer of 1 to 12, provided that when n is 2 or more, R₁s and R₂s may be independently the same or different.

14. The organic electroluminescence device according to claim 1, wherein the interfacial barrier reduction layer contains an arylphosphine oxide derivative shown by the following formula (2) and an arylamino compound: 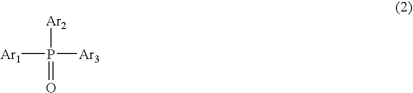
wherein Ar₁, Ar₂ and Ar₃ are independently an aromatic hydrocarbon group having 6 to 20 carbon atoms.
